(19) United States
(12) Patent Application Publication
(10) Pub. No.: US 2023/0168273 A1
(43) Pub. Date: Jun. 1, 2023

(54) Physical Quantity Sensor, Inertial Measurement Unit, and Manufacturing Method

(71) Applicant: SEIKO EPSON CORPORATION, Tokyo (JP)

(72) Inventor: Satoru TANAKA, Chino (JP)

(21) Appl. No.: 18/070,938

(22) Filed: Nov. 29, 2022

(30) Foreign Application Priority Data
Nov. 30, 2021 (JP) 2021-194018

(51) Int. Cl. G01P 15/125; G01P 15/08

(52) U.S. Cl. CPC G01P 15/125; G01P 15/0802

(57) ABSTRACT

In a physical quantity sensor, when a smaller thickness among thicknesses of first fixed electrodes in first fixed electrode portions in a third direction and thicknesses of first movable electrodes in a first movable electrode portion in the third direction is defined as TCA, in a side view in a second direction in a stationary state, one ends of the first movable electrodes on a third direction side are positioned on the third direction side by 4 μm or more and TCA/2 or less relative to one ends of the first fixed electrodes on the third direction side. When an opposite direction of the third direction is defined as a fourth direction, the other ends of the first movable electrodes on a fourth direction side are positioned on the third direction side relative to the other ends of the first fixed electrodes on the fourth direction side.

The present application is based on, and claims priority from JP Application Serial Number 2021-194018, filed Nov. 30, 2021, the disclosure of which is hereby incorporated by reference herein in its entirety.

### BACKGROUND

### 1. Technical Field

The present disclosure relates to a physical quantity sensor, an inertial measurement unit, a manufacturing method, and the like.

### 2. Related Art

JP-A-2018-515353 discloses, as a physical quantity sensor capable of measuring a physical quantity such as acceleration, a physical quantity sensor in which a part of a first fixed electrode partially overlaps with a movable electrode and a part of a second fixed electrode also overlaps with a part of the movable electrode in a side view in an X direction or a Y direction. According to this configuration, when the movable electrode moves in a +Z direction, a facing area between the movable electrode and the first fixed electrode increases, and when the movable electrode moves in a −Z direction, a facing area between the movable electrode and the second fixed electrode decreases, so that the physical quantity can be measured.

In the physical quantity sensor disclosed in JP-A-2018-515353, depending on an overlapping state between the movable electrode and the fixed electrode in the side view in the X direction or the Y direction, the physical quantity may not be accurately detected.

### SUMMARY

One aspect of the present disclosure relates to a physical quantity sensor configured to, when three directions orthogonal to one another are defined as a first direction, a second direction, and a third direction, detect a physical quantity in the third direction, including: a first fixed electrode portion provided at a substrate; and a first movable electrode portion, in which the first fixed electrode portion includes a first fixed electrode, the first movable electrode portion includes a first movable electrode facing the first fixed electrode of the first fixed electrode portion in the second direction, and when a smaller thickness of a thickness of the first fixed electrode in the third direction and a thickness of the first movable electrode in the third direction is defined as TCA, in a side view in the second direction in a stationary state, one end of the first movable electrode on a third direction side is positioned on the third direction side by 4 μm or more and TCA/2 or less relative to one end of the first fixed electrode on the third direction side, and when an opposite direction of the third direction is defined as a fourth direction, the other end of the first movable electrode on a fourth direction side is positioned on the third direction side relative to the other end of the first fixed electrode on the fourth direction side.

Another aspect of the present disclosure relates to an inertial measurement unit including: the physical quantity sensor described above and a control unit configured to perform control based on a detection signal output from the physical quantity sensor.

Another aspect of the present disclosure relates to a method of manufacturing a physical quantity sensor configured to, when three directions orthogonal to one another are defined as a first direction, a second direction, and a third direction, detect a physical quantity in the third direction, and the method including: a fixed electrode forming step of forming a first fixed electrode portion at a substrate; and a movable electrode forming step of forming a first movable electrode portion, in which the first fixed electrode portion includes a first fixed electrode, the first movable electrode portion includes a first movable electrode facing the first fixed electrode of the first fixed electrode portion in the second direction, and when a smaller thickness of a thickness of the first fixed electrode in the third direction and a thickness of the first movable electrode in the third direction is defined as TCA, in the movable electrode forming step, the first movable electrode portion is formed such that in a side view in the second direction, one end of the first movable electrode on a third direction side is positioned on the third direction side by 4 μm or more and TCA/2 or less relative to one end of the first fixed electrode on the third direction side, and when an opposite direction of the third direction is defined as a fourth direction, the other end of the first movable electrode on a fourth direction side is positioned on the third direction side relative to the other end of the first fixed electrode on the fourth direction side.

### BRIEF DESCRIPTION OF THE DRAWINGS

FIG. 1 is a configuration example of a physical quantity sensor according to the present embodiment.

FIG. 2 is a view showing an operation of a detection unit.

FIG. 3 is a view showing an operation in the detection unit.

FIG. 4 is a view showing operations in the detection units.

FIG. 5 is a view showing fringe capacitance.

FIG. 6 is a view showing dimensions of fixed electrodes and movable electrodes.

FIG. 7 is a view showing dimensions of the fixed electrodes and the movable electrodes.

FIG. 8 shows simulation results of changes in the fringe capacitance with respect to offset amounts.

FIG. 9 shows simulation results of changes in the fringe capacitance with respect to offset amounts.

FIG. 10 shows simulation results of changes in the fringe capacitance with respect to offset amounts.

FIG. 11 shows simulation results of changes in the fringe capacitance with respect to offset amounts.

FIG. 12 shows simulation results of changes in the fringe capacitance with respect to offset amounts.

FIG. 13 shows simulation results of changes in the fringe capacitance with respect to offset amounts.

FIG. 14 shows another configuration example of the present embodiment.

FIG. 15 shows another configuration example of the present embodiment.

FIG. 16 shows an example of an arrangement pattern of the fixed electrodes and the movable electrodes in a YZ cross section.

FIG. 17 shows an example of an arrangement pattern of the fixed electrodes and the movable electrodes in the YZ cross section.

FIG. 18 shows an example of arrangement patterns of the fixed electrodes and the movable electrodes in the YZ cross section.

FIG. 19 is a plan view showing a first detailed example of the physical quantity sensor.

FIG. 20 is a plan view showing a modification of the first detailed example of the physical quantity sensor.

FIG. 21 is a plan view showing a modification of the first detailed example of the physical quantity sensor.

FIG. 22 is a plan view showing a second detailed example of the physical quantity sensor.

FIG. 23 is a plan view showing a modification of the second detailed example of the physical quantity sensor.

FIG. 24 is a plan view showing a modification of the second detailed example of the physical quantity sensor.

FIG. 25 is a plan view showing a third detailed example of the physical quantity sensor.

FIG. 26 is a plan view showing a fourth detailed example of the physical quantity sensor.

FIG. 27 is an exploded perspective view showing a schematic configuration of an inertial measurement unit including the physical quantity sensor.

FIG. 28 is a perspective view of a circuit board of the physical quantity sensor.

FIG. 29 shows a first example of a method of manufacturing the physical quantity sensor according to the present embodiment.

FIG. 30 shows the first example of the method of manufacturing the physical quantity sensor according to the present embodiment.

FIG. 31 shows the first example of the method of manufacturing the physical quantity sensor according to the present embodiment.

FIG. 32 shows the first example of the method of manufacturing the physical quantity sensor according to the present embodiment.

FIG. 33 shows the first example of the method of manufacturing the physical quantity sensor according to the present embodiment.

FIG. 34 shows the first example of the method of manufacturing the physical quantity sensor according to the present embodiment.

FIG. 35 shows the first example of the method of manufacturing the physical quantity sensor according to the present embodiment.

FIG. 36 shows the first example of the method of manufacturing the physical quantity sensor according to the present embodiment.

FIG. 37 shows the first example of the method of manufacturing the physical quantity sensor according to the present embodiment.

FIG. 38 shows a second example of the method of manufacturing the physical quantity sensor according to the present embodiment.

FIG. 39 shows the second example of the method of manufacturing the physical quantity sensor according to the present embodiment.

FIG. 40 shows the second example of the method of manufacturing the physical quantity sensor according to the present embodiment.

FIG. 41 shows the second example of the method of manufacturing the physical quantity sensor according to the present embodiment.

FIG. 42 shows the second example of the method of manufacturing the physical quantity sensor according to the present embodiment.

### DESCRIPTION OF EXEMPLARY EMBODIMENTS

Hereinafter, a present embodiment will be described. The present embodiment to be described below does not unduly limit contents described in the claims. All configurations described in the present embodiment are not necessarily essential constituent elements.

### 1. Physical Quantity Sensor

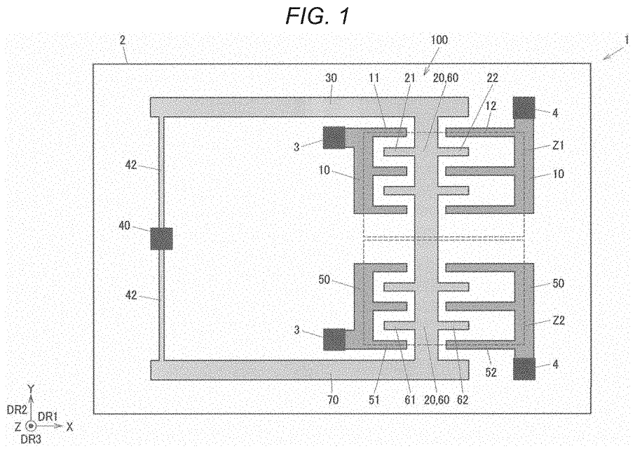

A configuration example of a physical quantity sensor 1 according to the present embodiment will be described with reference to FIG. 1 by taking an acceleration sensor which detects acceleration in a vertical direction as an example. FIG. 1 is a plan view of the physical quantity sensor 1 in a plan view in a direction orthogonal to a substrate 2. The physical quantity sensor 1 is a micro electro mechanical systems (MEMS) device, and is, for example, an inertial sensor.

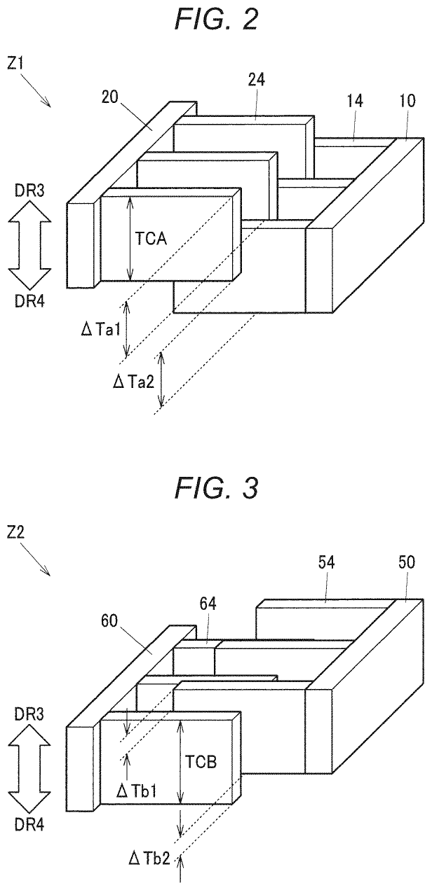

In FIG. 1, and FIGS. 2 to 26 and 29 to 42 to be described later, for convenience of description, a dimension of each member, an interval between members, and the like are schematically shown, and not all components are shown. For example, electrode wiring, an electrode terminal, and the like are not shown. In the following description, a case in which a physical quantity detected by the physical quantity sensor 1 is acceleration will be mainly described as an example. However, the physical quantity is not limited to the acceleration, and may be other physical quantities such as a velocity, pressure, displacement, an angular velocity, or gravity. The physical quantity sensor 1 may be used as a pressure sensor, a MEMS switch, or the like. In FIG. 1, directions orthogonal to one another are referred to as a first direction DR1, a second direction DR2, and a third direction DR3. The first direction DR1, the second direction DR2, and the third direction DR3 are, for example, an X-axis direction, a Y-axis direction, and a Z-axis direction, respectively, but are not limited thereto. For example, the third direction DR3 corresponding to the Z-axis direction is, for example, a direction orthogonal to the substrate 2 of the physical quantity sensor 1, and is, for example, the vertical direction. The first direction DR1 corresponding to the X-axis direction and the second direction DR2 corresponding to the Y-axis direction are directions orthogonal to the third direction DR3, and an XY plane which is a plane along the first direction DR1 and the second direction DR2 is, for example, along a horizontal plane. A fourth direction DR4 is an opposite direction of the third direction DR3, and is, for example, a direction on a negative side of the Z-axis direction. The term “orthogonal” includes not only a case of crossing at 90° but also a case of crossing at an angle slightly inclined from 90°.

The substrate 2 is, for example, a silicon substrate made of semiconductor silicon or a glass substrate made of a glass material such as borosilicate glass. A constituent material of the substrate 2 is not particularly limited, and a quartz substrate, a silicon on insulator (SOI) substrate, or the like may be used.

As shown in FIG. 1, the physical quantity sensor 1 according to the present embodiment can include first fixed electrode portions 10, a first movable electrode portion 20, a first coupling portion 30, second fixed electrode portions 50, a second movable electrode portion 60, a second coupling portion 70, a first fixing portion 40, and first support beams 42.

The first fixed electrode portions 10, the first movable electrode portion 20, the first coupling portion 30, the second fixed electrode portions 50, the second movable electrode portion 60, the second coupling portion 70, the first fixing portion 40, the first support beams 42, and the like form a first detection element 100 of the physical quantity sensor 1. For example, the first detection element 100 detects acceleration in a direction along the third direction DR3, which is the Z-axis direction, in a detection unit Z1 and a detection unit Z2. In the following description, a configuration when the physical quantity sensor 1 includes the second fixed electrode portions 50, the second movable electrode portion 60, and the second coupling portion 70 will be described as an example, but a configuration in which these portions are not provided may be adopted.

The first fixed electrode portions 10 include first fixed electrodes 11 and 12. The first fixed electrode portions 10 are provided at the substrate 2. Specifically, the first fixed electrode portions 10 are fixed to the substrate 2 by fixing portions 3 and 4. The plurality of first fixed electrodes 11 and 12 extend, for example, along the first direction DR1 which is the X-axis direction. For example, the first fixed electrode portions 10 are a first fixed electrode group.

The first movable electrode portion 20 includes first movable electrodes 21 and 22. The first movable electrodes 21 and 22 extend, for example, along the first direction DR1 which is the X-axis direction. The first movable electrodes 21 and 22 are provided such that the first movable electrode 21 of the first movable electrode portion 20 faces the first fixed electrode 11 of the first fixed electrode portion 10, and the first movable electrode 22 of the first movable electrode portion 20 faces the first fixed electrode 12 of the first fixed electrode portion 10. For example, the first movable electrode portion 20 is a first movable electrode group.

The second fixed electrode portions 50 include second fixed electrodes 51 and 52. The second fixed electrode portions 50 are provided at the substrate 2. Specifically, the second fixed electrode portions 50 are fixed to the substrate 2 by the fixing portions 3 and 4. The plurality of second fixed electrodes 51 and 52 extend, for example, along the first direction DR1 which is the X-axis direction. For example, the second fixed electrode portions 50 are a second fixed electrode group.

The second movable electrode portion 60 includes second movable electrodes 61 and 62. The second movable electrodes 61 and 62 extend, for example, along the first direction DR1 which is the X-axis direction. The second movable electrodes 61 and 62 are provided such that the second movable electrode 61 of the second movable electrode portion 60 faces the second fixed electrode 51 of the second fixed electrode portion 50, and the second movable electrode 62 of the second movable electrode portion 60 faces the second fixed electrode 52 of the second fixed electrode portion 50. For example, the second movable electrode portion 60 is a second movable electrode group.

For example, in FIG. 1, the first fixed electrode portions 10 are a comb-teeth fixed electrode group in which a plurality of fixed electrodes are arranged in a comb teeth shape in a plan view in the third direction DR3, and the first movable electrode portion 20 is a comb-teeth movable electrode group in which a plurality of movable electrodes are arranged in a comb teeth shape in the plan view in the third direction DR3. The second fixed electrode portions 50 are a comb-teeth fixed electrode group in which a plurality of fixed electrodes are arranged in a comb teeth shape in the plan view in the third direction DR3, and the second movable electrode portion 60 is a comb-teeth movable electrode group in which a plurality of movable electrodes are arranged in a comb teeth shape in the plan view in the third direction DR3.

In the detection unit Z1 of the first detection element 100, the first movable electrodes 21 of the first movable electrode portion 20 and the first fixed electrodes 11 of the first fixed electrode portion 10 alternately face each other, and the first movable electrodes 22 of the first movable electrode portion 20 and the first fixed electrodes 12 of the first fixed electrode portion 10 alternately face each other. In the detection unit Z2 of the first detection element 100, the second movable electrodes 61 of the second movable electrode portion 60 and the second fixed electrodes 51 of the second fixed electrode portion 50 alternately face each other, and the second movable electrodes 62 of the second movable electrode portion 60 and the second fixed electrodes 52 of the second fixed electrode portion 50 alternately face each other.

The first fixing portion 40 is fixed to the substrate 2. One end of the first support beam 42 is coupled to the first fixing portion 40. For example, the first support beam 42 is a torsion spring. In FIG. 1, two support beams are provided along the second direction DR2 so as to extend from the first fixing portion 40 in the second direction DR2 and in an opposite direction of the second direction DR2.

The first coupling portion 30 couples the other end of the first support beam 42, which is not coupled to the first fixing portion 40, and the first movable electrode portion 20. The second coupling portion 70 couples the second movable electrode portion 60 and the other end of the other first support beam 42, which is not coupled to the first fixing portion 40, provided on an opposite side of the first support beam 42.

The first fixing portion 40 is used as an anchor of a movable body including the first movable electrode portion 20 and the first coupling portion 30. The first fixing portion 40 is also used as an anchor of a second movable body including the second movable electrode portion 60 and the second coupling portion 70.

A movable body including the first movable electrode portion 20, the second movable electrode portion 60, and the like swings around a rotation axis along the second direction DR2 with the first fixing portion 40 as a fulcrum. For example, with the first support beam 42 along the second direction DR2 as the rotation axis, the movable body swings around the rotation axis while torsionally deforming the first support beam 42. Thus, the first detection element 100 having a one-side seesaw structure is implemented.

FIG. 2 is a perspective view of a fixed electrode 14 and a movable electrode 24 in the detection unit Z1 of the physical quantity sensor 1 according to the present embodiment. Here, the fixed electrode 14 corresponds to the first fixed electrodes 11 and 12 in FIG. 1, and the movable electrode 24 corresponds to the first movable electrodes 21 and 22 in FIG. 1. The fixed electrode 14 and the movable electrode 24 in the detection unit Z1 face each other so as to partially overlap each other when viewed from the second direction DR2, for example. Specifically, in the fixed electrode 14 and the movable electrode 24, an end portion of the movable electrode 24 in the third direction DR3 is positioned on a third direction DR3 side by ΔTₐ₁ relative to an end portion of the fixed electrode 14 in the third direction DR3. An end portion of the fixed electrode 14 in the fourth direction DR4 on an opposite side of the third direction DR3 is positioned on a fourth direction DR4 side by ΔTₐ₂ relative to an end portion of the movable electrode 24 in the fourth direction DR4. That is, the end portion of the movable electrode 24 in the third direction DR3 is offset from the end portion of the fixed electrode 14 in the third direction DR3 toward the third direction DR3 side by ΔTₐ₁, and the end portion of the fixed electrode 14 in the fourth direction DR4 is offset from the end portion of the movable electrode 24 in the fourth direction DR4 toward the fourth direction DR4 side by ΔTₐ₂. Further, when a smaller thickness of a thickness of the fixed electrode 14 and a thickness of the movable electrode 24 in the third direction DR3 is defined as TCA, the fixed electrode 14 and the movable electrode 24 are disposed such that the offset ΔTₐ₁ on the third direction DR3 side is 4 μm or more and TCA/2 or less. FIG. 2 illustrates a case in which the thickness of the movable electrode 24 in the third direction DR3 is smaller than the thickness of the fixed electrode 14. The offset ΔTₐ₂ on the fourth direction DR4 side is larger than zero.

FIG. 3 is a perspective view of a fixed electrode 54 and a movable electrode 64 in the detection unit Z2 of the physical quantity sensor 1 according to the present embodiment. Here, the fixed electrode 54 corresponds to the second fixed electrodes 51 and 52 in FIG. 1, and the movable electrode 64 corresponds to the second movable electrodes 61 and 62 in FIG. 1. The fixed electrode 54 and the movable electrode 64 in the detection unit Z2 face each other so as to partially overlap each other in the second direction DR2, for example. That is, in the fixed electrode 54 and the movable electrode 64, an end portion of the fixed electrode 54 in the third direction DR3 is positioned on the third direction DR3 side by ΔT_{b1} relative to an end portion of the movable electrode 64 in the third direction DR3. An end portion of the movable electrode 64 in the fourth direction DR4 is positioned on the fourth direction DR4 side by ΔT_{b2} relative to an end portion of the fixed electrode 54 in the fourth direction DR4. That is, the end portion of the fixed electrode 54 in the third direction DR3 is offset from the end portion of the movable electrode 64 in the third direction DR3 toward the third direction DR3 side by ΔT_{b1}, and the end portion of the movable electrode 64 in the fourth direction DR4 is offset from the end portion of the fixed electrode 54 in the fourth direction DR4 toward the fourth direction DR4 side by ΔT_{b2}. Further, when a smaller thickness of a thickness of the fixed electrode 54 and a thickness of the movable electrode 64 in the third direction DR3 is defined as TCB, the fixed electrode 54 and the movable electrode 64 are disposed such that the offset ΔT_{b1} on the third direction DR3 side is 4 μm or more and TCB/2 or less. FIG. 3 illustrates a case in which the thickness of the movable electrode 64 in the third direction DR3 is smaller than the thickness of the fixed electrode 54. The offset ΔT_{b2} on the fourth direction DR4 side is larger than zero.

As described above, when three directions orthogonal to one another are defined as the first direction DR1, the second direction DR2, and the third direction DR3, the physical quantity sensor 1 which detects a physical quantity in the third direction DR3 includes the first fixed electrode portions 10 provided at the substrate 2 and the first movable electrode portion 20. The first fixed electrode portions 10 include the first fixed electrodes 11 and 12, and the first movable electrode portion 20 includes the first movable electrodes 21 and 22 facing the first fixed electrodes 11 and 12 of the first fixed electrode portions 10 in the second direction DR2. When a smaller thickness of thicknesses of the first fixed electrodes 11 and 12 in the third direction DR3 and thicknesses of the first movable electrodes 21 and 22 in the third direction DR3 is defined as TCA, in a side view in the second direction DR2 in a stationary state, one ends of the first movable electrodes 21 and 22 on the third direction DR3 side are positioned on the third direction DR3 side by 4 μm or more and TCA/2 or less relative to one ends of the first fixed electrodes 11 and 12 on the third direction DR3 side. When the opposite direction of the third direction DR3 is defined as the fourth direction DR4, the other ends of the first movable electrodes 21 and 22 on the fourth direction DR4 side are positioned on the third direction DR3 side relative to the other ends of the first fixed electrodes 11 and 12 on the fourth direction DR4 side.

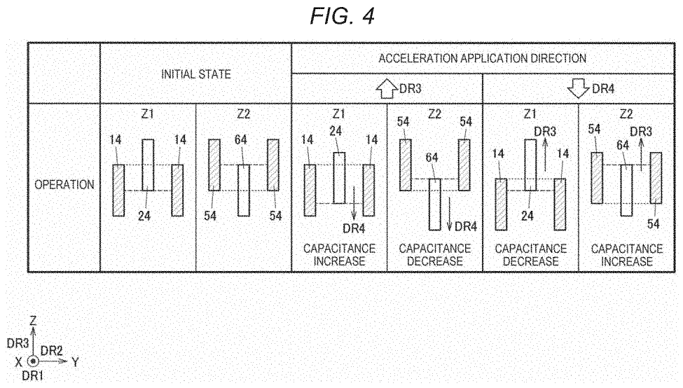

FIG. 4 is a diagram showing an operation of the detection units Z1 and Z2 of the physical quantity sensor 1 according to the present embodiment. Specifically, FIG. 4 shows an initial state and a state where acceleration is applied in cross-sectional views of the detection unit Z1 and the detection unit Z2 of the physical quantity sensor 1 shown in FIG. 1 as seen from the second direction DR2.

In the initial state, the fixed electrode 14 and the movable electrode 24 in the detection unit Z1 face each other so as to partially overlap each other along the second direction DR2, for example. The fixed electrode 14 and the movable electrode 24 are stationary in a state in which the end portion of the movable electrode 24 in the third direction DR3 is positioned in the third direction DR3 relative to the end portion of the fixed electrode 14 in the third direction DR3. The fixed electrode 54 and the movable electrode 64 in the detection unit Z2 also face each other so as to partially overlap each other in the second direction DR2, for example. The fixed electrode 54 and the movable electrode 64 are stationary in a state in which the end portion of the fixed electrode 54 in the third direction DR3 is positioned in the third direction DR3 relative to the end portion of the movable electrode 64 in the third direction DR3.

When acceleration in the third direction DR3 is generated from the initial state, the movable electrode 24 in the detection unit Z1 is displaced toward the fourth direction DR4 side as shown in FIG. 4. The movable electrode 64 in the detection unit Z2 is also displaced toward the fourth direction DR4 side. Accordingly, a facing area between the fixed electrode 14 and the movable electrode 24 increases in the detection unit Z1, and a facing area between the fixed electrode 54 and the movable electrode 64 decreases in the detection unit Z2. Therefore, the acceleration in the third direction DR3 can be detected by detecting an increase in capacitance due to an increase in the facing area in the detection unit Z1 and a decrease in capacitance due to a decrease in the facing area in the detection unit Z2.

On the other hand, when acceleration in the fourth direction DR4 is generated from the initial state, the movable electrode 24 in the detection unit Z1 is displaced toward the third direction DR3 side as shown in FIG. 4. The movable electrode 64 in the detection unit Z2 is also displaced toward the third direction DR3 side. Accordingly, the facing area between the fixed electrode 14 and the movable electrode 24 decreases in the detection unit Z1, and the facing area between the fixed electrode 54 and the movable electrode 64 increases in the detection unit Z2. Therefore, the acceleration in the fourth direction DR4 can be detected by detecting a decrease in capacitance due to a decrease in the facing area in the detection unit Z1 and an increase in capacitance due to an increase in the facing area in the detection unit Z2.

In the present embodiment, as shown in FIG. 2, the fixed electrode 14 and the movable electrode 24 in the detection unit Z1 have a structure in which the end portions are not flush with each other on both sides in the third direction DR3 and the fourth direction DR4. With such a structure, capacitance of the detection unit Z1 changes depending on application of acceleration in both the third direction DR3 and the fourth direction DR4. Therefore, the acceleration can be detected with high sensitivity as compared with a structure in which the end portions of the fixed electrode 14 and the movable electrode 24 in the detection unit Z1 are flush with each other in either the third direction DR3 or the fourth direction DR4, and only the acceleration in either the third direction DR3 or the fourth direction DR4 can be detected. Similarly, in the detection unit Z2, as shown in FIG. 3, the fixed electrode 54 and the movable electrode 64 have a structure in which the end portions are not flush with each other on both sides in the third direction DR3 and the fourth direction DR4. With such a structure, capacitance of the detection unit Z2 changes depending on application of acceleration in both the third direction DR3 and the fourth direction DR4. Therefore, the acceleration can be detected with high sensitivity as compared with a structure in which the end portions of the fixed electrode 54 and the movable electrode 64 in the detection unit Z2 are flush with each other in either the third direction DR3 or the fourth direction DR4, and only the acceleration in either the third direction DR3 or the fourth direction DR4 can be detected. By extending the first movable electrodes 21 and 22 on both sides in the first direction DR1, it is possible to cancel other-axis sensitivity in the first direction DR1. Further, the present embodiment has a structure in which the fixed electrode 14 and the movable electrode 24 can be offset on both surfaces in a +Z direction and a −Z direction without depending on an electrical or mechanical external factor. Since such a structure does not require an external factor, it is possible to implement high sensitivity of acceleration detection with a simple configuration without providing a new element. Therefore, it is possible to achieve both high sensitivity and low cost of the physical quantity sensor 1. It is desirable that materials of the first fixing portion 40, the first support beam 42, the first fixed electrode portion 10, the first movable electrode portion 20, the second fixed electrode portion 50, the second movable electrode portion 60, and the like are all made of the same material in consideration of an influence by a difference in linear expansion coefficient due to composition of different materials on a temperature characteristic such as warpage.

As an acceleration sensor in a Z direction, JP-A-2018-515353 discloses an acceleration sensor using a change in the above facing area. The physical quantity sensor is also disposed such that one ends of the fixed electrode and the movable electrode in the Z direction are not flush with each other, and one ends of the fixed electrode and the movable electrode in the −Z direction are also not flush with each other.

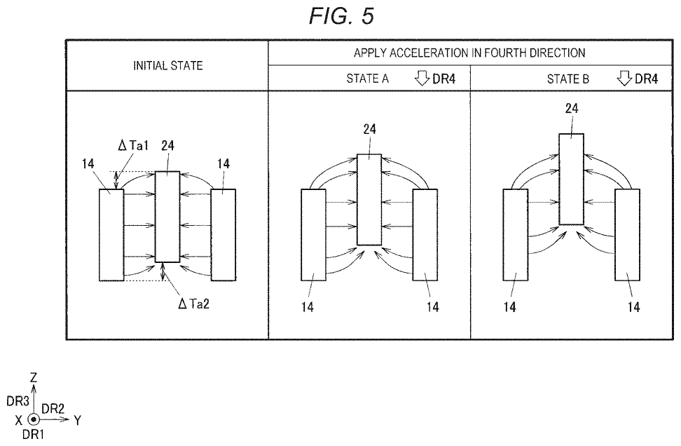

FIG. 5 is a diagram showing states of electric lines of force generated between the fixed electrode 14 and the movable electrode 24 when the fixed electrode 14 and the movable electrode 24 are disposed such that one ends of the fixed electrode 14 and the movable electrode 24 are not flush with each other in each of the +Z direction and the −Z direction.

First, in an initial state, electric lines of force are generated perpendicularly from the fixed electrode 14 toward the movable electrode 24 in a portion of the facing area between the fixed electrode 14 and the movable electrode 24. Since there is no fixed electrode 14 facing the movable electrode 24 in a portion offset by ΔTₐ₁ in the third direction DR3, electric lines of force are obliquely output from the end portion of the fixed electrode 14 in the third direction DR3. In the fourth direction DR4, since there is no movable electrode 24 facing the fixed electrode 14 in a portion offset by ΔTₐ₂ in the fourth direction DR4, electric lines of force are also obliquely output from the end portion of the movable electrode 24 in the fourth direction.

Next, a case in which acceleration is applied in the fourth direction DR4 is shown while being separated into a state A and a state B. Here, the state A indicates a state in which the acceleration in the fourth direction DR4 is applied and the movable electrode 24 is displaced in the third direction DR3. The state B shows a state in which the movable electrode 24 is further subjected to the acceleration in the fourth direction DR4 from the state A and is displaced in the third direction DR3. In the state A, the movable electrode 24 is displaced toward the third direction DR3 side, so that the offsets ΔTₐ₁ and ΔTₐ₂ in the initial state are increased. Since there is no fixed electrode 14 to face an increased offset portion, the number of electric lines of force obliquely outputting from the end portion of the fixed electrode 14 in the third direction further increases. Similarly, in the fourth direction DR4, the offset which is ΔTₐ₂ in the initial state increases, and in a portion where there is no movable electrode 24 to face the increased portion in the fixed electrode 14, electric lines of force obliquely outputting from the end portion of the movable electrode 24 in the fourth direction increases. That is, when the movable electrode 24 moves in the +Z direction from the initial state in which the offset is small, a change in the electric lines of force between the fixed electrode 14 and the movable electrode 24 in a portion where the offset is increased is considered to be large because components of the electric lines of force obliquely output from an end portion of one electrode is likely to increase.

In the state B, the movable electrode 24 is further displaced in the third direction DR3 from the state A, and the offset is further increased. Here, in the state A within a certain range from the initial state, electric lines of force obliquely outputting from the end portion of the fixed electrode 14 increase according to an increase in an offset amount, but when the offset increases beyond the range, an amount of the electric lines of force obliquely outputting from the end portion of the fixed electrode 14 is gradually saturated. The state B shows a state of electric lines of force in a saturated region. That is, with respect to an increase in the offset amount between the fixed electrode 14 and the movable electrode 24 from the state A to the state B, the amount of the electric lines of force obliquely output from the end portion of the fixed electrode 14 hardly increases. That is, when the offset in the initial state becomes large to some extent, it is considered that a change in the electric lines of force obliquely output from the end portion of the fixed electrode 14 becomes gentle. The same applies to the electric lines of force obliquely output from the end portion of the movable electrode 24 in the fourth direction DR4.

Thus, with respect to an electric field generated perpendicularly to a portion where the fixed electrode 14 and the movable electrode 24 face each other, an electric field generated due to the electric lines of force coming around from the end portion of the fixed electrode 14 or the movable electrode 24 is referred to as a fringe electric field. Capacitance based on a perpendicular electric field generated in the portion where the electrodes face each other increases or decreases in proportion to the facing area, but capacitance based on the fringe electric field, that is, fringe capacitance does not behave simply proportional to the facing area between the electrodes. When the fixed electrode 14 and the movable electrode 24 are processed by etching, plasma ions are obliquely implanted into a side surface of the electrode, and roughness on the side surface of the electrode is deteriorated. On the other hand, since the fringe capacitance is very sensitive to a shape of the side surface of the electrode, the fringe capacitance tends to vary greatly for each electrode. Thus, a component of the fringe capacitance contained in a change in the capacitance becomes a factor which deteriorates detection accuracy of the acceleration. Therefore, in the physical quantity sensor using a change in the facing area between the electrodes, it is desirable that a detected change in the capacitance does not include the component of the fringe capacitance.

In this regard, in the physical quantity sensor disclosed in JP-A-2018-515353, as described above, a structure is adopted in which an offset can be made on both sides of the fixed electrode and the movable electrode to implement high sensitivity of acceleration detection, but there is no specific description of an influence of an offset amount between end portions of the fixed electrode and the movable electrode. Therefore, it is difficult to minimize an influence of the above fringe capacitance and detect the acceleration with high accuracy. In the physical quantity sensor, since the facing area between the fixed electrode and the movable electrode is small, a movable range is narrow. That is, a detectable range of the acceleration may be narrow.

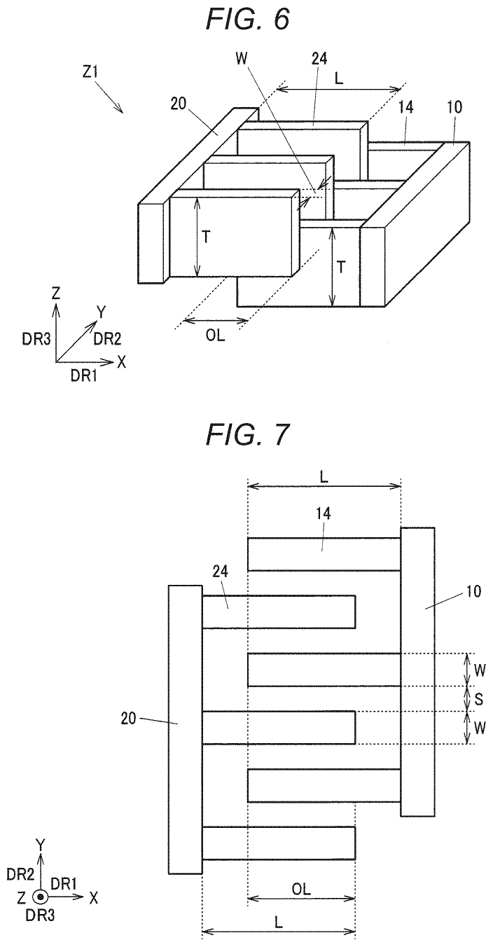

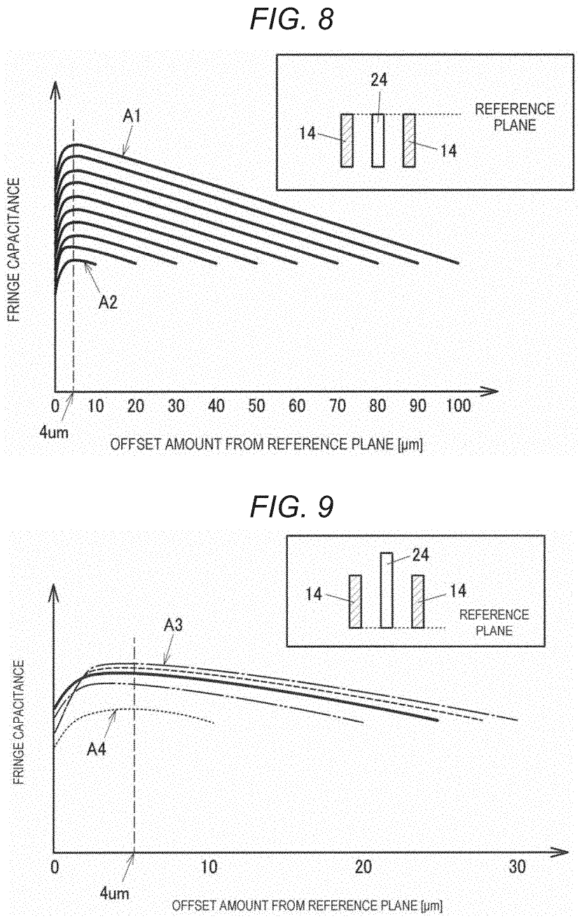

FIGS. 8 to 13 show results obtained by simulating fringe capacitance of the fixed electrode 14 and the movable electrode 24 under various electrode dimensions. Here, behavior of the fringe capacitance is simulated when a thickness T of the two electrodes in the third direction DR3, a width W of the two electrodes in the second direction DR2, a space S of a gap between the fixed electrode 14 and the movable electrode 24, a length L of the two electrodes in the first direction DR1, and a facing length OL as shown in FIGS. 6 and 7 are changed with respect to standard dimension conditions. Under the standard dimension conditions, the thickness T is 30 μm, the width W is 2 μm, the space S is 2 μm, the length L is 110 μm, and the facing length OL is 100 μm. In FIGS. 8 to 13, the fixed electrode 14 and the movable electrode 24 are described as an example, and fringe capacitance between the fixed electrode 54 and the movable electrode 64 may be used, for example.

FIG. 8 shows results of a simulation verification of changes in the fringe capacitance when the movable electrode 24 is offset from a reference plane in which one ends of the fixed electrode 14 and the movable electrode 24 match each other in the third direction DR3, as shown in FIG. 8, based on the standard dimension conditions. The fringe capacitance on a vertical axis is obtained by subtracting capacitance, which is obtained based on an equation for obtaining capacitance of a parallel plate capacitor, from a total capacitance between the fixed electrode 14 and the movable electrode 24 which is obtained by simulation. That is, the fringe capacitance on the vertical axis is capacitance corresponding to fringe electric fields generated between the end portions of the fixed electrode 14 and the movable electrode 24. The thickness of the fixed electrode 14 and the thickness T of the movable electrode 24 are equal to each other, and are changed in a range of 10 μm to 100 μm at intervals of 10 μm. Data corresponding to 100 μm is A1, and data corresponding to 10 μm is A2. From this result, it can be seen that the fringe capacitance rapidly changes at an offset amount of less than 4 μm from the reference plane at any thickness T. When detection is performed in a range in which a fringe capacitance fluctuation is large, there is no problem as long as shapes of the fixed electrode 14 and the movable electrode 24 are made beautifully, but in reality there is side surface roughness or the like. Since the fringe capacitance is very sensitive to the shape of the side surface of the electrode, a variation is likely to occur, and detection accuracy is greatly affected. Therefore, in a range in which the fringe capacitance fluctuation is small with an offset of 4 μm or more, it is possible to ensure a margin for a shape variation due to a process, and it is possible to perform highly accurate detection.

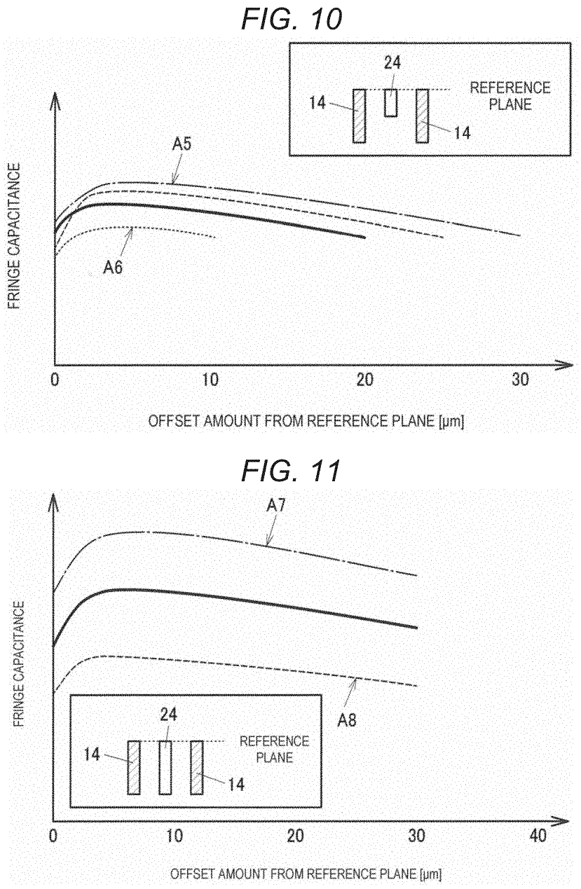

FIG. 9 shows simulation results under the standard dimension conditions when the thickness T of the movable electrode 24 is fixed to 30 μm and the thickness of the fixed electrode 14 is changed within a range equal to or less than the thickness of the movable electrode 24. Data when the thickness T of the fixed electrode 14 is 30 μm corresponds to A3, and data when the thickness T of the fixed electrode 14 is 10 μm corresponds to A4. In this case, similarly to FIG. 8, it can also be seen that the fringe capacitance fluctuation is large when the offset amount from the reference plane is less than 4 μm. FIG. 10 shows simulation results under the standard dimension conditions when the thickness T of the fixed electrode 14 is fixed to 30 μm and the thickness of the movable electrode 24 is changed within a range equal to or less than the thickness of the fixed electrode 14. Data when the thickness T of the movable electrode 24 is 30 μm corresponds to A5, and data when the thickness T of the movable electrode 24 is 10 μm corresponds to A6. In this case, similarly, it can also be seen that the fringe capacitance fluctuation is large when the offset amount from the reference plane is less than 4 μm. As described above, as a result of simulating patterns in which the facing area decreases, when the fixed electrode 14, which is flush with the movable electrode 24 on the third direction DR3 side or the fourth direction DR4 side, is displaced in a range of less than 4 μm from the reference plane, the fringe capacitance fluctuation tends to increase.

FIG. 11 shows simulation results of the fringe capacitance under the standard dimension conditions when the thickness T of the fixed electrode 14 and the movable electrode 24 is fixed to 30 μm and the width W of the two electrodes in the second direction DR2 is changed to 2 μm, 5 μm, and 10 μm. Data when the width W of the two electrodes is 10 μm corresponds to A7, and data when the width W of the two electrodes is 2 μm corresponds to A8. Similarly to the above, the fringe capacitance fluctuation is large when the offset amount from the reference plane is less than 4 μm. As a detailed tendency, when the width W of the two electrodes is increased to 10 μm, an offset amount range in which the fringe capacitance fluctuation is large is 4 μm or more. Increasing the width W of the electrode makes it difficult to reduce a size of a device, so that it is desirable to set the width W to 5 μm or less.

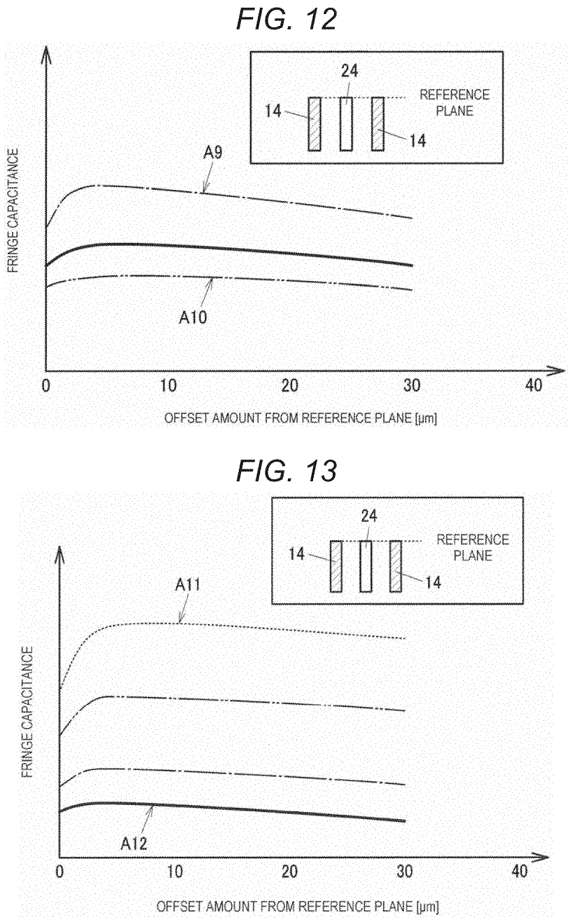

FIG. 12 shows simulation results of the fringe capacitance fluctuation under the standard dimension conditions when the thickness T of the fixed electrode 14 and the movable electrode 24 is fixed to 30 μm and the space S of the gap between the two electrodes is changed to 2 μm, 5 μm, and 10 μm. Data when the space S is 2 μm corresponds to A9, and data when the space S is 10 μm corresponds to A10. Similarly to the above, the fringe capacitance fluctuation is large when the offset amount from the reference plane is less than 4 μm. As a detailed tendency, when the space S is widened to such as 10 μm, the offset amount range in which the fringe capacitance fluctuation is large is 4 μm or more, and there is no rapid fluctuation. When the space S is too large, the capacitance may decrease and acceleration detection sensitivity may decrease. Therefore, it is desirable that the space S is 5 μm or less.

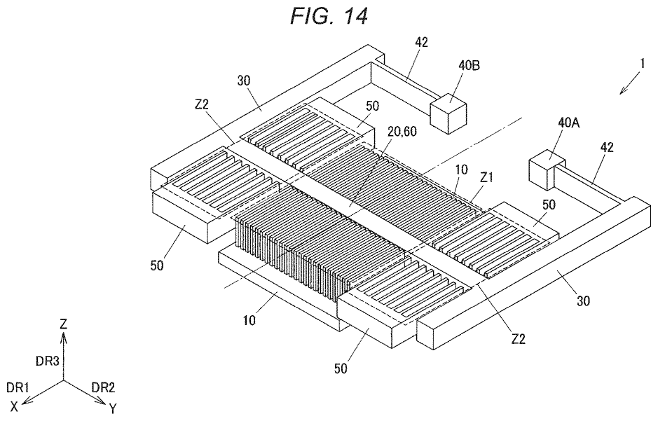

FIG. 13 shows simulation results of the fringe capacitance under the standard dimension conditions when the thickness T of the fixed electrode 14 and the movable electrode 24 is fixed to 30 μm and the facing length OL of the two electrodes is changed to 50 μm, 100 μm, 200 μm, and 300 μm. Data when the facing length OL is 300 μm corresponds to A11, and data when the facing length OL is 50 μm corresponds to A12. Similarly to the above, the fringe capacitance fluctuation is large when the offset amount from the reference plane is less than 4 μm. When the facing length OL is too long, there is concern about a problem of sticking, and rigidity of the electrode also becomes weak. Therefore, it is desirable that the facing length OL is about 300 μm or less. For each dimension described above, for example, the thickness T of each electrode is desirably designed such that facing areas between the electrodes in the detection units Z1 and Z2 are substantially the same in order to bring the offset of the capacitance close to zero. The length L of each electrode and the space S between the electrodes may be changed within a range in which an offset of the capacitance does not become large.

Thus, when dimensions of the fixed electrode 14 and the movable electrode 24 are changed under the standard dimension conditions, the fringe capacitance fluctuation increases at the offset of less than 4 μm from the reference plane where the one ends of the two electrodes match each other in the third direction DR3. Therefore, by ensuring the offset amount to be 4 μm or more from the reference plane of the fixed electrode 14 and the movable electrode 24, the movable electrode 24 can move in a region where the fringe capacitance fluctuation is gentle while avoiding a region where a rapid fluctuation in the fringe capacitance appears, and the acceleration can be detected with high accuracy.

By setting the offset to be the thickness TCA or less, a movable range of the movable electrode 24 can be maximized in the third direction DR3 and the fourth direction DR4. As described above, by ensuring the offset to be 4 μm or more, it is possible to avoid the region where the rapid fluctuation in the fringe capacitance appears, but on the other hand, when the offset increases, the facing area of the fixed electrode 14 and the movable electrode 24 decreases, and the movable range of the movable electrode 24 is limited. That is, a range in which the acceleration can be detected is narrowed. Therefore, it is desirable to ensure the maximum movable range while avoiding the region where the rapid fluctuation in the fringe capacitance appears. It is desirable to ensure the same movable range in each of the third direction DR3 and the fourth direction DR4. From such a viewpoint, by setting an upper limit of the offset to ½ of the smaller thickness TCA or less of the thicknesses of the fixed electrode 14 and the movable electrode 24, the same movable range is ensured with respect to the acceleration in either the third direction DR3 or the fourth direction DR4, and narrowing of the movable range in either direction can be avoided. Therefore, by ensuring the offset to be 4 μm or more and setting the offset to ½ of the smaller thickness TCA or less of the thicknesses of the fixed electrode 14 and the movable electrode 24, it is possible to implement both high accuracy of acceleration detection and maximization of a detectable range of acceleration.

By setting a lower limit of the offset to a value of 6 μm to 8 μm or more in particular, it is possible to more reliably obtain an effect of avoiding the rapid fluctuation in the fringe capacitance. That is, when the movable electrode 24 is largely displaced in the fourth direction DR4, it is also considered that the offset on the third direction DR3 side falls within a range of less than 4 μm in which the change in the fringe capacitance is rapid. Therefore, for example, when TCA is set to 30 μm, it is desirable that the lower limit of the offset is set to 6 μm to 8 μm or more and the upper limit is set to 15 μm or less.

In the present embodiment, the other ends of the first movable electrodes 21 and 22 on the fourth direction DR4 side may be positioned on the third direction DR3 side by 4 μm or more and ½ of the thickness TCA or less relative to the other ends of the first fixed electrodes 11 and 12 on the fourth direction DR4 side.

In portions of the fixed electrode 14 and the movable electrode 24 close to the end portions in the −Z direction, plasma ions are likely to bounce off from a bottom of a processed groove in a processing process such as etching and be implanted into the surface to cause irregularities in a surface shape. On the other hand, the above fringe electric field is sensitive to such a roughness shape of a surface of the electrode. When the roughness shape is deteriorated in the vicinity of the end portion of the electrode, the fringe electric field increases, and a change with respect to displacement of the movable electrode 24 also increases. That is, the change in the fringe capacitance tends to increase on the fourth direction DR4 side, and the detection accuracy of the acceleration tends to deteriorate. Therefore, according to the present embodiment, each of the offset ΔTₐ₁ on the third direction DR3 side in a stationary state and the offset ΔTₐ₂ on the fourth direction DR4 side can be ensured to be 4 μm or more, so that in particular, the acceleration can be detected with high accuracy while avoiding a large change in the fringe capacitance on the fourth direction DR4 side.

In the present embodiment, the second fixed electrode portions 50 provided at the substrate 2 and the second movable electrode portion 60 are provided. The second fixed electrode portions 50 include the second fixed electrodes 51 and 52, and the second movable electrode portion 60 includes the second movable electrodes 61 and 62 facing the second fixed electrodes 51 and 52 of the second fixed electrode portions 50 in the second direction DR2. When a smaller thickness of thicknesses of the second fixed electrodes 51 and 52 in the third direction DR3 and thicknesses of the second movable electrodes 61 and 62 in the third direction DR3 is defined as TCB, in the side view in the stationary state, one ends of the second movable electrodes 61 and 62 on the fourth direction DR4 side are positioned on the fourth direction DR4 side by 4 μm or more and TCB/2 or less relative to one ends of the second fixed electrodes 51 and 52 on the fourth direction DR4 side. The other ends of the second movable electrodes 61 and 62 on the third direction DR3 side are positioned on the fourth direction DR4 side relative to the other ends of the second fixed electrodes 51 and 52 on the third direction DR3 side.

An influence of the rapid change in the fringe capacitance appears not only in the fixed electrode 14 and the movable electrode 24 in the detection unit Z1 but also in the fixed electrode 54 and the movable electrode 64 in the detection unit Z2 in a similar manner. Therefore, according to the present embodiment, in the detection unit Z2, it is also possible to avoid a region where a rapid change in the fringe capacitance appears due to an offset of the movable electrode 64 in the fourth direction DR4. Therefore, in both of the detection units Z1 and Z2, the acceleration can be detected with high accuracy and the detectable range of the acceleration can be maximized.

In the present embodiment, the other ends of the first movable electrodes 21 and 22 on the third direction DR3 side may be positioned on the fourth direction DR4 side by 4 μm or more and TCB/2 or less relative to the other ends of the first fixed electrodes 11 and 12 on the third direction DR3 side.

Thus, in each of the detection units Z1 and Z2, it is possible to detect a change in the capacitance while avoiding a region where a rapid change in the fringe capacitance appears on both the third direction DR3 side and the fourth direction DR4 side, so that the acceleration can be detected with high accuracy.

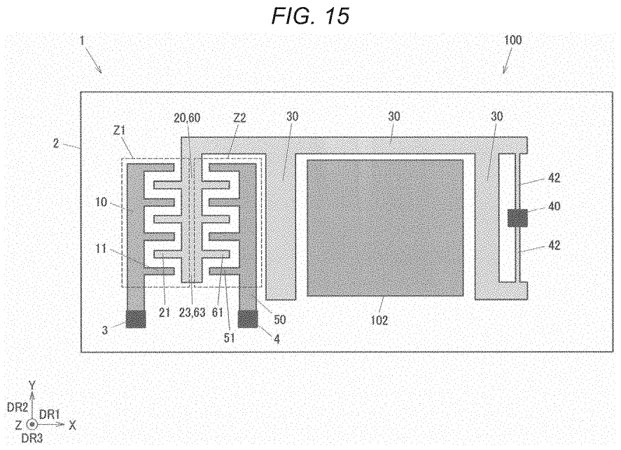

FIGS. 14 and 15 show modifications of a configuration shown in FIG. 1. FIG. 14 is an example in which an arrangement pattern of the detection unit Z1 and the detection unit Z2 is different from that of the configuration example shown in FIG. 1. Specifically, the detection unit Z1 is sandwiched between the detection units Z2 in the second direction DR2. Thus, by disposing the detection units Z1 and Z2, it is possible to stabilize a position of a center of gravity of a movable body including the movable electrodes 24 and 64. That is, the detection units Z1 and Z2 having different movable-electrode thickness patterns are symmetrical with respect to a line along an X axis indicated by a one-dot chain line in FIG. 14. Thus, a mass imbalance due to configuration positions of the movable electrodes 24 and 54 can be eliminated, and the acceleration can be detected with high accuracy. In the present embodiment, one or both of the detection unit Z1 and the detection unit Z2 may be divided, and a structure in which the detection unit Z2 is sandwiched between the detection units Z1 may be adopted.

FIG. 15 is different from the configuration example shown in FIG. 1 in a shape of the first coupling portion 30. In the configuration example of FIG. 1, the detection units Z1 and Z2 are disposed adjacently along the second direction DR2, but in a configuration example of FIG. 15, the detection units Z1 and Z2 are disposed adjacently along the first direction DR1. A second detection element 102 is provided in a space surrounded by the first coupling portion 30. The second detection element 102 is, for example, a physical quantity sensor which detects acceleration in the first direction DR1 or the second direction DR2. The first fixed electrode portion 10, the first movable electrode portion 20, the second movable electrode portion 60, the second fixed electrode portion 50, the first coupling portion 30, the second detection element 102, the first coupling portion 30, and the first fixing portion 40 are arranged in this order along the first direction DR1. With such a configuration, the same effect as that of the configuration example shown in FIG. 1 can be obtained, and the acceleration in the first direction DR1 or the second direction DR2 can also be detected together with the acceleration in the third direction DR3.

FIG. 16 shows a cross-sectional structure of the detection units Z1 and Z2 of the physical quantity sensor 1 according to the present embodiment as viewed from a first direction DR1 side. As described above, as an example in which the offset ΔTₐ₁ from the reference plane on the third direction DR3 side is set to 4 μm≤ΔTₐ₁≤TCA/2, and the offset ΔTₐ₂ from the reference plane on the fourth direction DR4 side is set to zero or more, or 4 μm≤ΔTₐ₂≤TCA/2, there is a pattern shown in FIG. 16, for example. That is, in this pattern, a position of the end portion of the movable electrode 24 in the detection unit Z1 on the third direction DR3 side and a position of the end portion of the fixed electrode 54 in the detection unit Z2 on the third direction DR3 side in the third direction DR3 are flush with each other, and a position of the end portion of the fixed electrode 14 in the detection unit Z1 on the fourth direction DR4 side and a position of the movable electrode 64 in the detection unit Z2 on the fourth direction DR4 side are flush with each other. Here, a position of the end portion of the fixed electrode 14 in the detection unit Z1 in the third direction DR3 is different from a position of the end portion of the movable electrode 64 in the detection unit Z2 in the third direction DR3. A position of the end portion of the movable electrode 24 in the detection unit Z1 in the fourth direction DR4 is also different from a position of the end portion of the fixed electrode 54 in the detection unit Z2 in the fourth direction DR4.

That is, in the physical quantity sensor 1 according to the present embodiment, in the side view in the stationary state, positions of the one ends of the first movable electrodes 21 and 22 on the third direction DR3 side may match positions of the other ends of the second fixed electrodes 51 and 52 on the third direction DR3 side, and positions of the other ends of the first fixed electrodes 11 and 12 on the fourth direction DR4 side may match positions of the one ends of the second movable electrodes 61 and 62 on the fourth direction DR4 side.

The position of each end portion of the fixed electrodes 14 and 54 and the movable electrodes 24 and 64 in the third direction DR3 is a part of a wafer surface after a surface polishing process such as chemical mechanical polishing (CMP) or a processing process such as etching. Therefore, when a surface after the process is represented by “contour lines” indicated by broken lines in FIG. 16, the number of contour lines is six in the pattern shown in FIG. 16. Here, since the number of contour lines directly leads to an increase in manufacturing cost and difficulty of a manufacturing process is increased, it is desirable to adopt an arrangement pattern of electrodes in which the number of contour lines is minimized. Therefore, according to the present embodiment, positions of one ends of the movable electrode 24 and the fixed electrode 54 on the third direction DR3 side match each other, and positions of one ends of the fixed electrode 14 and the movable electrode 64 on the fourth direction DR4 side match each other, so that the number of contour lines can be reduced. Therefore, the physical quantity sensor 1 capable of detecting the acceleration with high accuracy can be manufactured at low cost.

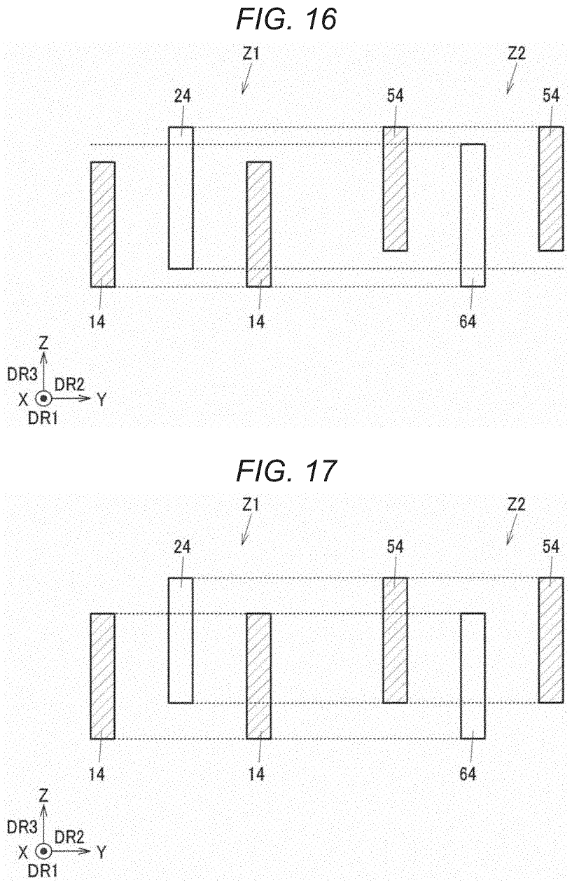

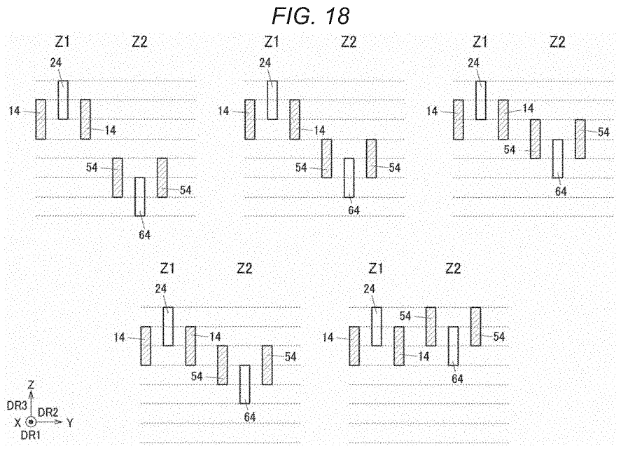

Similarly to FIG. 16, FIG. 17 shows a cross-sectional structure of the detection units Z1 and Z2 of the physical quantity sensor 1 according to the present embodiment as viewed from the first direction DR1 side. FIG. 17 shows an arrangement pattern of electrodes different from that in FIG. 16. A difference from the arrangement pattern shown in FIG. 16 is that a position of one end of the fixed electrode 14 in the detection unit Z1 in the third direction DR3 and a position of one end of the movable electrode 64 in the detection unit Z2 in the third direction DR3 are flush with each other. A position of one end of the movable electrode 24 in the detection unit Z1 in the fourth direction DR4 and a position of one end of the fixed electrode 54 in the detection unit Z2 in the fourth direction DR4 are flush with each other.

That is, in the physical quantity sensor 1 according to the present embodiment, in the side view in the stationary state, positions of the other ends of the first movable electrodes 21 and 22 on the fourth direction DR4 side may match positions of the one ends of the second fixed electrodes 51 and 52 on the fourth direction DR4 side, and positions of the one ends of the first fixed electrodes 11 and 12 on the third direction DR3 side may match positions of the other ends of the second movable electrodes 61 and 62 on the third direction DR3 side.

In the arrangement pattern shown in FIG. 16, the number of contour lines indicated by broken lines is six, but in the arrangement pattern shown in FIG. 17, the number of contour lines is reduced to four. Therefore, in this manner, the physical quantity sensor 1 capable of detecting the acceleration with high accuracy can be manufactured at lower cost due to reduction in the number of contour lines.

Thus, several variations are considered for an arrangement pattern of the fixed electrodes 14 and 54 and the movable electrodes 24 and 64. FIG. 18 illustrates arrangement patterns of the fixed electrodes 14 and 54 and the movable electrodes 24 and 64. An upper part of FIG. 18 shows arrangement patterns when the number of contour lines is 8, 7, and 6 from a left, and a lower part of FIG. 18 shows arrangement patterns when the number of contour lines is 6 and 4 from the left. The arrangement pattern shown in FIG. 17 is the same as an example shown on a right side in the lower part of FIG. 18. In any of the arrangement patterns shown in FIG. 18, the offset of the end portion of the electrode can be within a predetermined range, and the change in the capacitance can be detected while avoiding the region where the rapid fluctuation in the fringe capacitance appears. However, as described above, since the number of contour lines directly leads to an increase in the manufacturing cost and difficulty of the manufacturing process is increased, it is desirable to adopt the arrangement pattern of electrodes in which the number of contour lines is minimized. In this regard, when the arrangement pattern with a minimum number of contour lines of 4 is adopted as shown in FIG. 17, the physical quantity sensor 1 capable of detecting the acceleration with high accuracy can be manufactured at the lowest cost.

### 2. Detailed Configuration Example

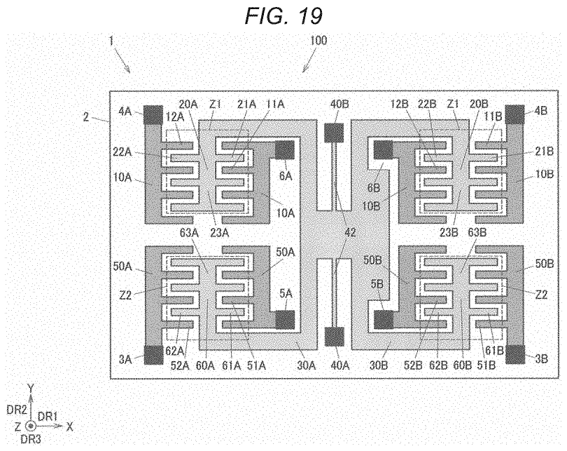

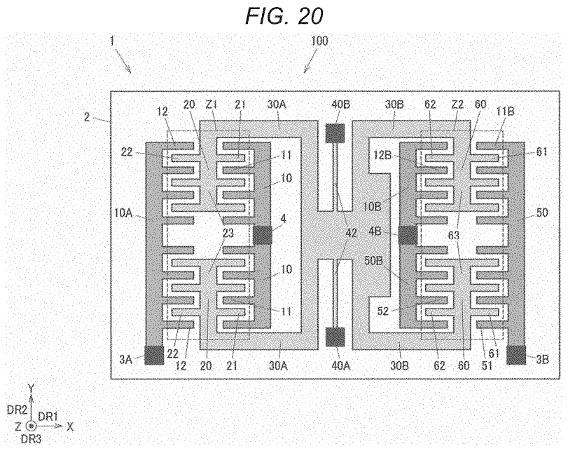

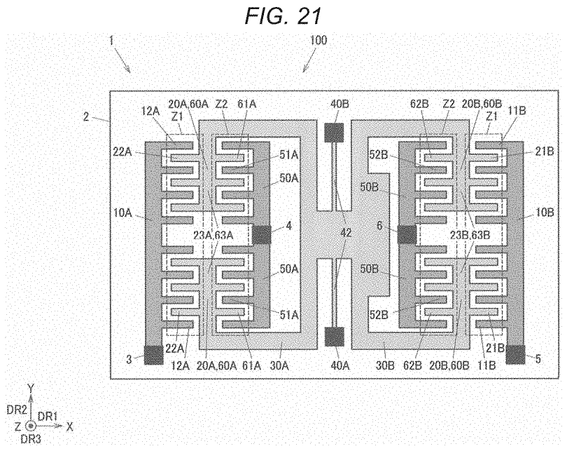

Next, a detailed configuration example of the physical quantity sensor 1 according to the present embodiment will be described. FIGS. 19 to 21 show examples in which the configuration example of FIG. 1 is replaced with a two-side seesaw structure. FIG. 19 is a first detailed example of the present embodiment. In the first detailed example, as compared with the configuration example shown in FIG. 1, first movable electrode portions 20A and 20B and second movable electrode portions 60A and 60B are provided on both sides of the first support beam 42. Therefore, the first coupling portion 30 is also divided into first coupling portions 30A and 30B extending from the first support beam 42 to a left and right. As shown in FIG. 19, the movable body including the first movable electrode portions 20A and 20B and the second movable electrode portions 60A and 60B of the first detailed example has an asymmetric shape with respect to a Y axis including the first support beam 42. Specifically, a thickness of the coupling portion 30B provided between the first support beam 42 and a first fixed electrode portion 10B and a thickness of the coupling portion 30B provided between the first support beam 42 and a second fixed electrode portion 50B are different. This is because when a shape of the movable body is symmetrical with respect to a rotation axis including the support beam 42, there arises a situation in which torque is balanced with respect to acceleration in the Z direction and seesaw motion is not performed. Thus, the asymmetric shape is adopted to avoid such a situation. The same applies to configuration examples shown in FIGS. 20 and 21 to be described later. The shape in which the movable body is asymmetric with respect to the rotation axis including the support beam 42 is not limited to a shape shown in FIG. 19. According to the first detailed example, since the electrodes for detecting the capacitance can be provided on both sides of the rotation axis, it is possible to implement high sensitivity of acceleration detection.

The first fixing portion 40 corresponding to an anchor portion of a one-side seesaw in the configuration example of FIG. 1 is replaced with two anchors which are first fixing portions 40A and 40B for fixing in the first detailed example. Here, the movable body including the first movable electrode portions 20A and 20B and the second movable electrode portions 60A and 60B is fixed to the substrate 2 by the two fixing portions, the first fixing portions 40A and 40B, so that rigidity against swinging motion in the XY plane is increased. Therefore, when an impact is applied in the XY plane, the rotation axis including the first support beam 42 is less likely to be displaced, so that impact resistance is improved. Therefore, the detection accuracy when the physical quantity sensor 1 detects the acceleration in the third direction DR3 can be improved.

FIG. 20 is a modification of the first detailed example. A difference from the first detailed example is an arrangement pattern of the detection units Z1 and Z2. In the modification shown in FIG. 20, the first movable electrode portion 20 is provided with the detection unit Z1, and the second movable electrode portion 60 is provided with the detection unit Z2. That is, the detection unit Z1 is provided on one side of a two-side seesaw, and the detection unit Z2 is provided on the other side of the two-side seesaw. According to such a configuration, as described with reference to FIG. 14, it is possible to eliminate the mass imbalance caused by arrangement of the detection units Z1 and Z2 having different electrode thickness patterns along the second direction DR2, and it is possible to detect the acceleration with high accuracy.

FIG. 21 is another modification of the first detailed example. This is an example in which the arrangement pattern of the detection units Z1 and Z2 is changed in a similar manner as in the above modification. Specifically, the detection units are disposed in an order of the detection unit Z1, the detection unit Z2, the detection unit Z2, and the detection unit Z1 along the first direction DR1 in an XY plan view. Since the detection unit Z1 and the detection unit Z2 are not disposed adjacently along the second direction DR2, the mass imbalance can be avoided. Along the first direction DR1, the detection unit Z1 and the detection unit Z2 are disposed symmetrically with respect to the first support beam 42, so that the mass imbalance can be eliminated in an entire two-side seesaw, and the acceleration can be detected with higher accuracy. When the movable electrodes 24 are extended on both sides of first base movable electrodes 23A and 23B and the movable electrodes 64 are extended on both sides of second base movable electrodes 63A and 63B, the other-axis sensitivity cannot be reduced unless the detection units Z1 and Z2 are disposed such that the thickness of the electrode changes on the first direction DR1 side and on an opposite side of the first direction DR1 side.

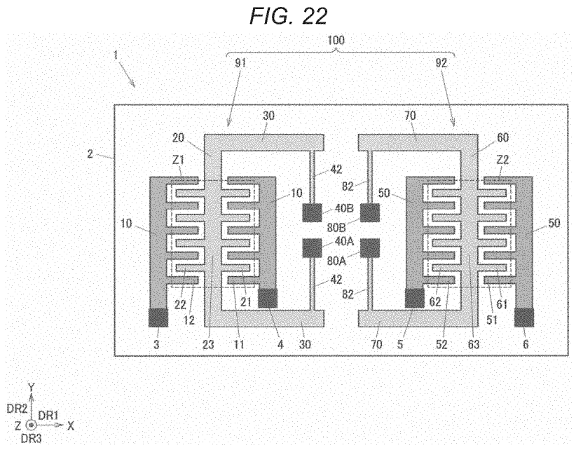

FIGS. 22 to 24 show configuration examples when the one-side seesaw structure of the configuration example shown in FIG. 1 is provided on two elements. FIG. 22 is a second detailed example of the present embodiment. The second detailed example is different from the configuration example shown in FIG. 1 in that the first detection element 100 includes a first element part 91 and a second element part 92. In the configuration example of FIG. 1, using the first fixing portion 40 as the anchor, the movable body including the first coupling portion 30 and the first movable electrode portion 20 performs one-side seesaw motion, so that the facing areas between the fixed electrode 14 and the movable electrodes 24, and between the fixed electrode 54 and the movable electrode 64 are changed. On the other hand, in the second detailed example, two such one-side seesaw type elements are provided, and the acceleration in the third direction DR3 can be detected in each element.

In the configuration example shown in FIG. 1, the detection unit Z1 and the detection unit Z2 are disposed adjacently along the second direction DR2 which is the rotation axis in a one seesaw structure, on the other hand, in the second detailed example, one detection unit Z1 is provided in the first element part 91 and one detection unit Z2 is provided in a seesaw in the second element part 92. In the configuration example shown in FIG. 1, the one-side seesaw is fixed by one anchor which is the first fixing portion 40, on the other hand, in the second detailed example, a seesaw is fixed by two anchors which are the first fixing portions 40A and 40B. The second element part 92 has a similar configuration as the first element part 91, and the first element part 91 and the second element part 92 are provided adjacently along the first direction DR1 so as to be line-symmetrical with respect to the Y axis.

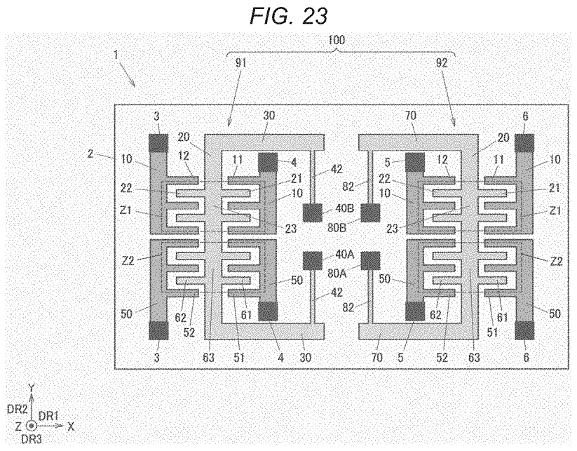

FIG. 23 is a modification of the second detailed example in which the arrangement pattern of the detection units Z1 and Z2 is changed. Specifically, in the first element part 91, the detection units Z1 and Z2 are disposed adjacently in an order of the detection unit Z2 and the detection unit Z1 along the second direction DR2. In the second element part 92, the detection units Z1 and Z2 are also disposed adjacently in an order of the detection unit Z2 and the detection unit Z1 along the second direction DR2. A configuration in which two elements are provided with such a one-side seesaw structure has higher acceleration detection sensitivity than the two-side seesaw structure shown in FIGS. 19 to 21. With the same spring structure, by adopting such a configuration, it is possible to gain the displacement, and it is possible to improve acceleration detection sensitivity.

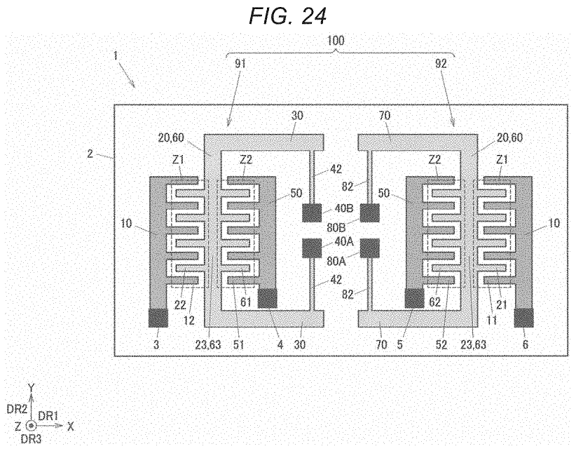

FIG. 24 is a modification of the second detailed example of the present embodiment. A difference from the second detailed example is that in both the first element part 91 and the second element part 92, the detection units Z1 and Z2 are disposed adjacently along the first direction DR1.

That is, the physical quantity sensor 1 according to the present embodiment may include the first fixing portions 40A and 40B, the first support beams 42 having one ends coupled to the first fixing portions 40A and 40B, the first coupling portion 30 coupling the other ends of the first support beams 42 and the first movable electrode portion 20, second fixing portions 80A and 80B, second support beams 82 having one ends coupled to the second fixing portions 80A and 80B, and second coupling portions 70 coupling the other ends of the second support beams 82 and the second movable electrode portion 60.

Thus, the acceleration can be detected by the two elements as compared with the configuration example shown in FIG. 1, so that it is possible to implement high sensitivity of acceleration detection. Since the mass imbalance in the second direction DR2 due to the detection units Z1 and Z2 being provided along the second direction DR2 can be eliminated, the acceleration can be detected with high accuracy. As compared with an example of the two-side seesaw structure shown in FIGS. 19 to 21, it is possible to implement high sensitivity of acceleration detection in the same size. With the same acceleration detection sensitivity, spring rigidity can be increased, and impact resistance can be improved.

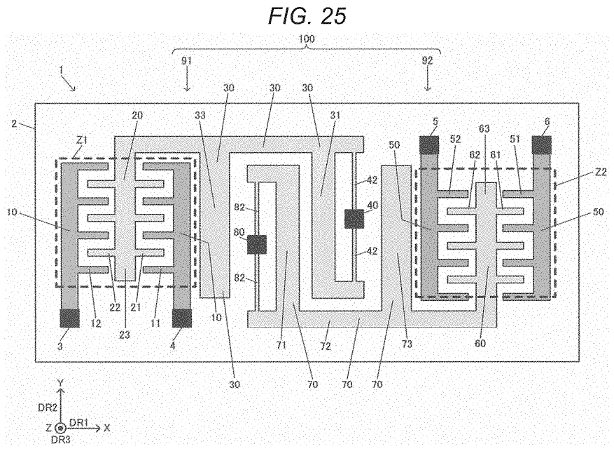

FIG. 25 is a third detailed example of the present embodiment. In the third detailed example, similarly to the configuration example shown in FIGS. 22 to 24, the first element part 91 and the second element part 92 having a one-side seesaw structure are disposed adjacently along the first direction DR1. Shapes of the first element part 91 and the second element part 92 are different from the configuration examples shown in FIGS. 22 to 24. Specifically, the first element part 91 and the second element part 92 of the third detailed example each have the same shape as the first detection element 100 of the configuration example shown in FIG. 15. A second fixing portion 80, the second support beams 82, and a fourth portion 71 of the second element part 92 are disposed in a space surrounded by a first portion 31, a second portion 32, and a third portion 33 of the first coupling portion 30 in the first element part 91. The first fixing portion 40, the first support beams 42, and the first portion 31 in the first element part 91 are disposed in a space surrounded by the fourth portion 71, a fifth portion 72, and a sixth portion 73 of the second coupling portion 70 in the second element part 92. That is, the first element part 91 and the second element part 92 are disposed adjacently along the first direction DR1 with an anchor portion of one element part disposed in a space formed by a part of the coupling portion of the other element part.

That is, in the physical quantity sensor 1 according to the present embodiment, in the plan view in the third direction DR3, the first movable electrode portion 20, the second fixing portion 80, the first fixing portion 40, and the second movable electrode portion 60 may be arranged adjacently along the first direction DR1 in an order of the first movable electrode portion 20, the second fixing portion 80, the first fixing portion 40, and the second movable electrode portion 60.

According to the third detailed example, the second fixing portion 80 can be disposed using a space between the first fixing portion 40 and the first movable electrode portion 20, and the first fixing portion 40 can be disposed using a space between the second fixing portion 80 and the second movable electrode portion 60. Therefore, the first movable electrode portion 20, the second fixing portion 80, the first fixing portion 40, and the second movable electrode portion 60 can be arranged compactly along the first direction DR1. Therefore, the physical quantity sensor 1 can be reduced in size, and the first fixing portion 40 and the second fixing portion 80 can be disposed close to each other, so that deterioration in acceleration detection accuracy due to an influence of warpage of the substrate 2 or the like of the physical quantity sensor 1 can be minimized. Therefore, it is possible to implement both small size and high accuracy of the physical quantity sensor 1.

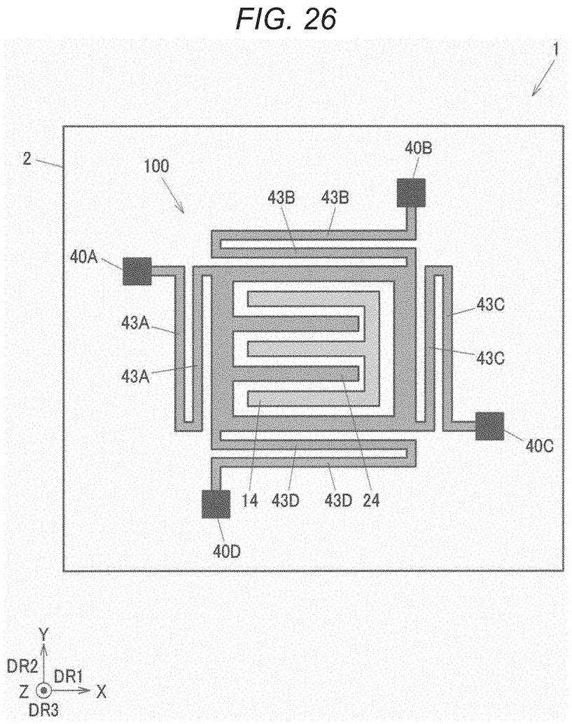

FIG. 26 is a fourth detailed example of the physical quantity sensor 1 according to the present embodiment. The fourth detailed example is an example in which an element structure displaced in a pure out-of-plane direction is adopted as a method of detecting the acceleration in the third direction DR3, unlike the example in which torsional motion generated by the seesaw structure described in each of the above configuration examples is adopted. A configuration example shown in FIG. 26 includes the fixed electrode 14, the movable electrode 24, first support beams 43A, 43B, 43C, and 43D, and first fixing portions 40A, 40B, 40C, and 40D. In the present embodiment, the movable electrode 24 faces the fixed electrode 14 in the second direction DR2. The movable electrode 24 is fixed to the substrate 2 by the first fixing portions 40A, 40B, 40C, and 40D via the first support beams 43A, 43B, 43C, and 43D in a +X direction, a −X direction, a +Y direction, and a −Y direction, respectively. Each of the first support beams 43A, 43B, 43C, and 43D functions as a spring to pull back the movable electrode 24 when the movable electrode 24 moves along the third direction DR3.

Thus, by setting the offset ΔTₐ₁ of the end portions of the fixed electrode 14 and the movable electrode 24 in the third direction in the range of 4 μm≤ΔTₐ₁≤TCA/2 and setting ΔTₐ₂ in the range of 4 μm≤ΔTₐ₂≤TCA/2, it is possible to achieve both high accuracy of acceleration detection and maximization of the detectable range of acceleration.

### 3. Inertial Measurement Unit

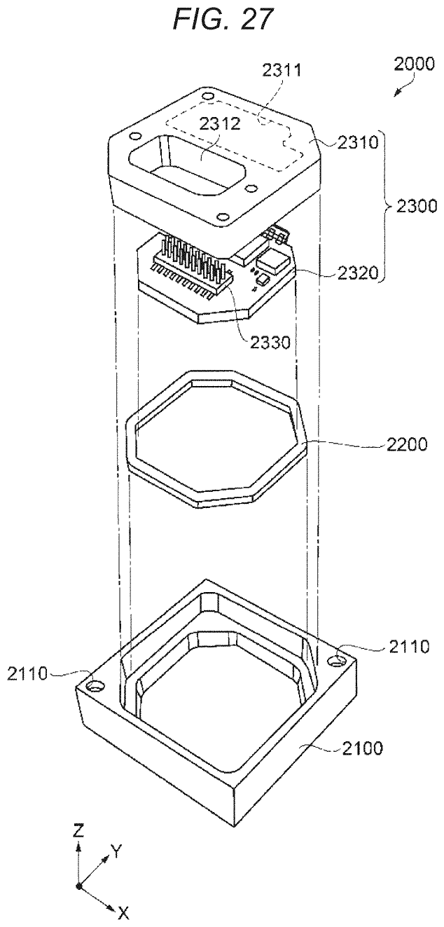

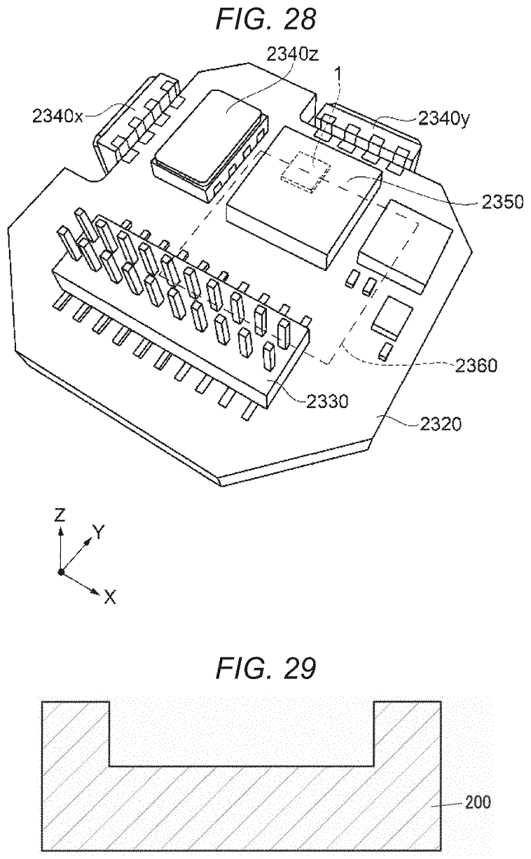

Next, an example of an inertial measurement unit 2000 according to the present embodiment will be described with reference to FIGS. 27 and 28. The inertial measurement unit (IMU) 2000 shown in FIG. 27 is a device for detecting inertial momentum such as a posture or a behavior of a moving body such as an automobile or a robot. The inertial measurement unit 2000 is a so-called six-axis motion sensor including an acceleration sensor for detecting acceleration ax, ay, and az in directions along three axes and an angular velocity sensor for detecting angular velocities ωx, ωy, and ωz around the three axes.

The inertial measurement unit 2000 is a rectangular parallelepiped having a substantially square planar shape. Screw holes 2110 as mount portions are formed in the vicinity of two vertexes positioned in a diagonal direction of a square. Two screws can be inserted into the screw holes 2110 at two places to fix the inertial measurement unit 2000 to a mounted surface of a mounted body such as an automobile. By selecting a component or changing a design, a size of the inertial measurement unit 2000 can be reduced to such a size that the inertial measurement unit 2000 can be mounted on a smartphone or a digital camera, for example.

The inertial measurement unit 2000 includes an outer case 2100, a bonding member 2200, and a sensor module 2300, and has a configuration in which the sensor module 2300 is inserted inside the outer case 2100 with the bonding member 2200 sandwiched between the sensor module 2300 and the outer case 2100. The sensor module 2300 includes an inner case 2310 and a circuit board 2320. In the inner case 2310, a recess portion 2311 for preventing contact with the circuit board 2320 and an opening 2312 for exposing a connector 2330 to be described later are formed. The circuit board 2320 is bonded to a lower surface of the inner case 2310 via an adhesive.

As shown in FIG. 28, the connector 2330, an angular velocity sensor 2340z for detecting an angular velocity around a Z axis, an acceleration sensor unit 2350 for detecting acceleration in each axial direction of the X axis, the Y axis, and the Z axis, and the like are mounted at an upper surface of the circuit board 2320. An angular velocity sensor 2340x for detecting an angular velocity around the X axis and an angular velocity sensor 2340y for detecting an angular velocity around the Y axis are mounted at a side surface of the circuit board 2320.

The acceleration sensor unit 2350 includes at least the physical quantity sensor 1 for measuring the acceleration in the Z-axis direction described above, and can detect acceleration in one axial direction or acceleration in two axial directions or three axial directions as necessary. The angular velocity sensors 2340x, 2340y, and 2340z are not particularly limited. For example, a vibration gyro sensor using Coriolis force can be used.

A control IC 2360 is mounted at a lower surface of the circuit board 2320. The control IC 2360 as a control unit for performing control based on a detection signal output from the physical quantity sensor 1 is, for example, a micro controller unit (MCU), includes a storage unit including a nonvolatile memory, an A/D converter, and the like, and controls each unit of the inertial measurement unit 2000. A plurality of electronic components are also mounted on the circuit board 2320.

As described above, the inertial measurement unit 2000 according to the present embodiment includes the physical quantity sensor 1 and the control IC 2360 serving as the control unit for performing control based on the detection signal output from the physical quantity sensor 1. According to the inertial measurement unit 2000, since the acceleration sensor unit 2350 including the physical quantity sensor 1 is used, an effect of the physical quantity sensor 1 can be achieved, and the inertial measurement unit 2000 capable of implementing high accuracy and the like can be provided.

The inertial measurement unit 2000 is not limited to the configuration in FIGS. 27 and 28. For example, the inertial measurement unit 2000 may have a configuration in which only the physical quantity sensor 1 is provided as an inertial sensor without providing the angular velocity sensors 2340x, 2340y, and 2340z. In this case, for example, the inertial measurement unit 2000 may be implemented by accommodating the physical quantity sensor 1 and the control IC 2360, by which the control unit is implemented, in a package which is an accommodation container.

### 4. Manufacturing Method

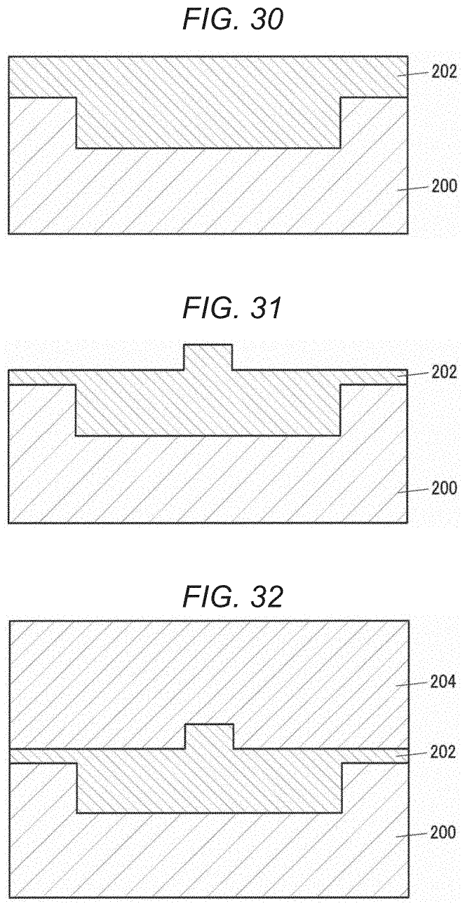

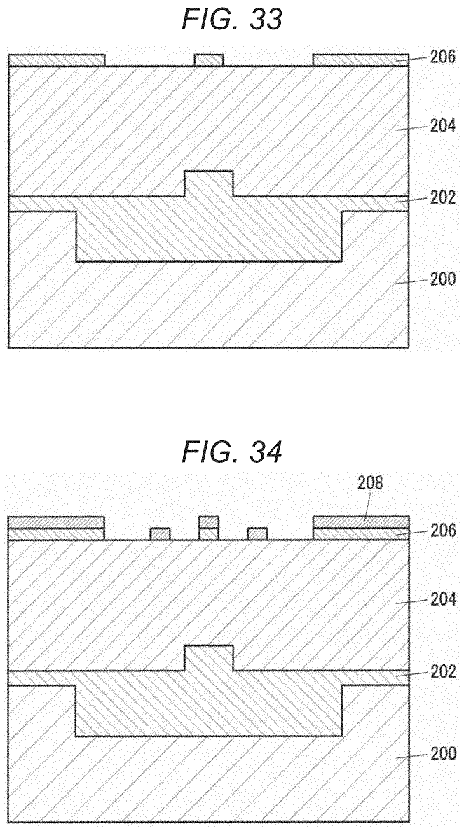

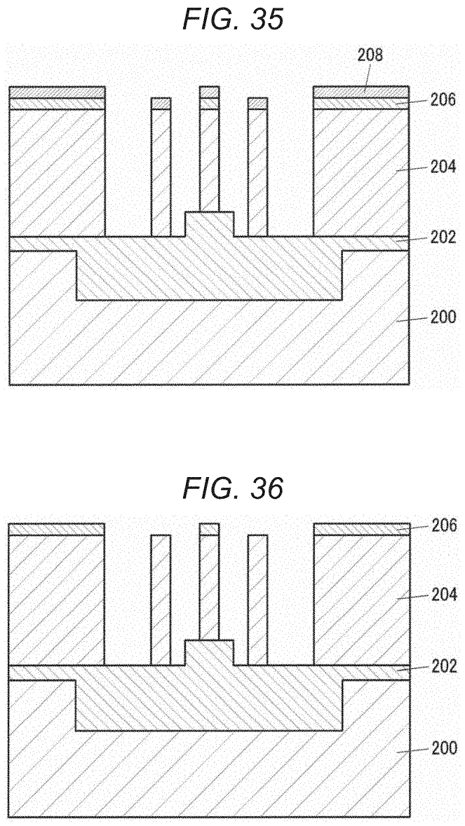

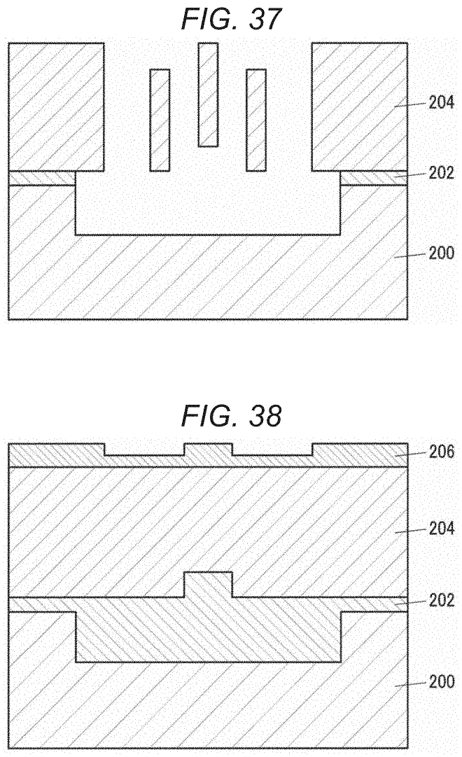

Finally, the manufacturing method according to the present embodiment will be described. FIGS. 29 to 37 show a first example of the manufacturing method according to the present embodiment. First, as shown in FIG. 29, a recess portion is formed in a support substrate 200 by etching. As shown in FIG. 30, the recess portion is filled with a sacrificial layer 202 to planarize a surface. Next, as shown in FIG. 31, a projection portion is formed by etching at a surface of the sacrificial layer 202 formed in FIG. 30. As shown in FIG. 32, a structure body layer 204 is provided at the surface of the sacrificial layer 202 to planarize the surface. Next, as shown in FIG. 33, a hard mask 206 is provided at a surface of the structure body layer 204 planarized in FIG. 32, and an electrode whose thickness is not started from the surface of the structure body layer 204 is patterned. As shown in FIG. 34, a resist mask 208 is provided, and an electrode whose thickness is started from the surface of the structure body layer 204 is patterned. Next, as shown in FIG. 35, the structure body layer 204 is processed by etching to form a structure body. As shown in FIG. 36, the resist mask 208 is erased, and the structure body layer 204 is processed by etching. Finally, as shown in FIG. 37, the hard mask 206 and the sacrificial layer 202 are erased by wet etching or the like. Thus, the physical quantity sensor 1 according to the present embodiment can be manufactured.

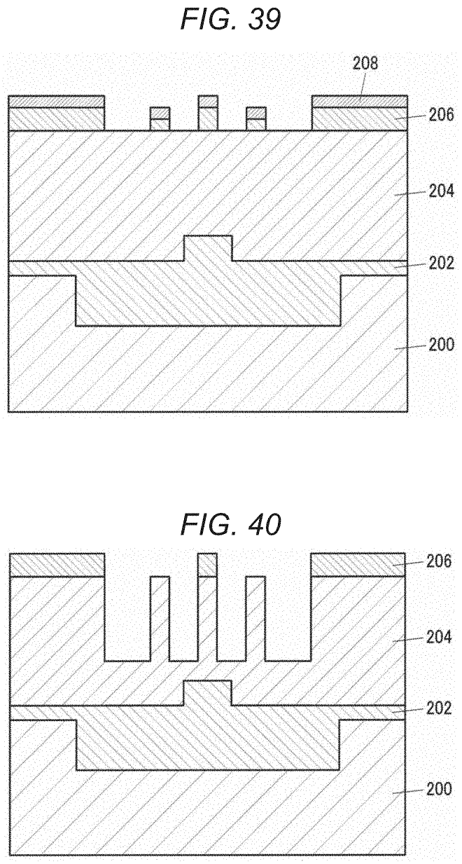

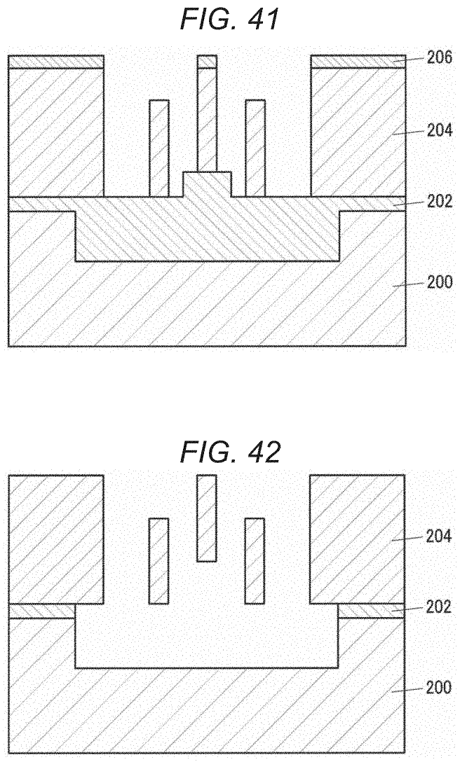

FIGS. 38 to 42 show a second example of the manufacturing method according to the present embodiment. The second example is the same as the first example in manufacturing steps shown in FIGS. 29 to 33. In the second embodiment, after the structure body layer 204 is provided and planarized in FIG. 33, the hard mask 206 is provided at the surface of the structure body layer 204 in FIG. 38, and the hard mask 206 is processed by etching to reduce a thickness in a region where the electrode whose thickness is started from the surface of the structure body layer 204 is present. Next, as shown in FIG. 39, a structure body shape is patterned with the resist mask 208, and the hard mask 206 is processed by etching. As shown in FIG. 40, after the resist mask 208 is erased, the structure body layer 204 is processed by etching using the hard mask 206 as a mask material. Since the hard mask 206 is also processed in this etching, etching of the structure body layer 204 starts with a time difference in a portion where a thickness is thin. As shown in FIG. 41, by etching the structure body layer 204 as it is, the fixed electrode 14 and the movable electrode 24 are formed. Finally, as shown in FIG. 42, the hard mask 206 and the sacrificial layer 202 are erased by wet etching or the like. Thus, the physical quantity sensor 1 according to the present embodiment can be manufactured. For example, RIE etching or the like can be used for a process based on the etching described above. A polishing process such as CMP can be used for planarization processing.

As described above, the manufacturing method according to the present embodiment is a manufacturing method of the physical quantity sensor 1 that detects, when the three directions orthogonal to one another are defined as the first direction DR1, the second direction DR2, and the third direction DR3, the physical quantity in the third direction DR3, and the manufacturing method includes: a fixed electrode forming step of forming the first fixed electrode portions 10 at the substrate 2; and a movable electrode forming step of forming the first movable electrode portion 20. The first fixed electrode portions 10 include the first fixed electrodes 11 and 12, and the first movable electrode portion 20 includes the first movable electrodes 21 and 22 facing the first fixed electrodes 11 and 12 of the first fixed electrode portions 10 in the second direction DR2. When the smaller thickness of the thicknesses of the first fixed electrodes 11 and 12 in the third direction DR3 and the thicknesses of the first movable electrodes 21 and 22 in the third direction DR3 is defined as TCA, in the movable electrode forming step, in the side view in the second direction DR2, the one ends of the first movable electrodes 21 and 22 on the third direction DR3 side are positioned on the third direction DR3 side by 4 μm or more and TCA/2 or less relative to the one ends of the first fixed electrodes 11 and 12 on the third direction DR3 side. When the opposite direction of the third direction DR3 is defined as the fourth direction DR4, the first movable electrode portion 20 can be formed such that the other ends of the first movable electrodes 21 and 22 on the fourth direction DR4 side are positioned on the third direction DR3 side relative to the other ends of the first fixed electrodes 11 and 12 on the fourth direction DR4 side.

As described with reference to FIGS. 16 to 18, in order to implement a two-side offset structure in which one ends of the fixed electrode 14 and the movable electrode 24 are not flush with each other in the +Z direction and the −Z direction, many manufacturing steps are required, and difficulty of the manufacturing process is increased. This also leads to an increase in the manufacturing cost. How to implement such a shape with a low-cost and simple manufacturing process is important. In this regard, according to the present embodiment, the sacrificial layer 202 is formed in advance on the fourth direction DR4 side of the structure body layer 204, and after a process of portions corresponding to the fixed electrode 14 and the movable electrode 24 is ended, the sacrificial layer 202 can be isotropically peeled off by wet etching. Therefore, the shapes of the fixed electrode 14 and the movable electrode 24 can be set to shapes of a two-side offset while reducing the number of manufacturing steps and process difficulty.

The first example and the second example described above are examples of the manufacturing method using a thin film process, but other than this, a silicon on insulator (SOI) process may be used. For example, a wafer bonding technique can be used. As compared with the thin film process shown in the first example and the second example, in the SOI process, parasitic capacitance between the substrate 2 and the fixed electrode 14, the movable electrode 24, and the like can be reduced, so that high accuracy of acceleration detection can be performed.

As described above, the physical quantity sensor according to the present embodiment configured to, when three directions orthogonal to one another are defined as a first direction, a second direction, and a third direction, detect a physical quantity in the third direction, includes: a first fixed electrode portion provided at a substrate; and a first movable electrode portion. The first fixed electrode portion includes a first fixed electrode, and the first movable electrode portion includes a first movable electrode facing the first fixed electrode of the first fixed electrode portion in the second direction. When a smaller thickness of a thickness of the first fixed electrode in the third direction and a thickness of the first movable electrode in the third direction is defined as TCA, in a side view in the second direction in a stationary state, one end of the first movable electrode on a third direction side is positioned on the third direction side by 4 μm or more and TCA/2 or less relative to one end of the first fixed electrode on the third direction side. When an opposite direction of the third direction is defined as a fourth direction, the other end of the first movable electrode on a fourth direction side is positioned on the third direction side relative to the other end of the first fixed electrode on the fourth direction side.

According to the present embodiment, by ensuring the offset to be 4 μm or more and TCA/2 or less, it is possible to implement both high accuracy of physical quantity detection and maximization of the detectable range.

In the present embodiment, the other end of the first movable electrode on the fourth direction side may be positioned on the third direction side by 4 μm or more and ½ the thickness TCA or less relative to the other end of the first fixed electrode on the fourth direction side.

Thus, it is possible to ensure an offset of 4 μm or more on each of the third direction side and the fourth direction side. Therefore, even on the fourth direction side where a change in fringe capacitance remarkably appears, it is possible to avoid the rapid change in the fringe capacitance and detect the physical quantity with high accuracy.

The physical quantity sensor according to the present embodiment further includes a second fixed electrode portion provided at the substrate; and a second movable electrode portion. The second fixed electrode portion includes a second fixed electrode, and the second movable electrode portion includes a second movable electrode facing the second fixed electrode of the second fixed electrode portion in the second direction. When a smaller thickness of a thickness of the second fixed electrode in the third direction and a thickness of the second movable electrode in the third direction is defined as TCB, in the side view in the stationary state, one end of the second movable electrode on the fourth direction side is positioned on the fourth direction side by 4 μm or more and TCB/2 or less relative to one end of the second fixed electrode on the fourth direction side. The other end of the second movable electrode on the third direction side may be positioned on the fourth direction side relative to the other end of the second fixed electrode on the third direction side.

Thus, in any of the detection units of the first detection element, it is possible to avoid a region where a rapid fluctuation in the fringe capacitance appears. Therefore, the physical quantity can be detected with higher accuracy and the detectable range of the physical quantity can be maximized.

In the present embodiment, the other end of the second movable electrode on the third direction side may be positioned on the fourth direction side by 4 μm or more and TCB/2 or less relative to the other end of the second fixed electrode on the third direction side.

Thus, in any of the detection units in the first detection element, it is possible to detect a change in the capacitance while avoiding a region where a rapid change in the fringe capacitance appears on both the third direction side and the fourth direction side, so that the physical quantity can be detected with higher accuracy.

In the present embodiment, in the side view in the stationary state, a position of the one end of the first movable electrode on the third direction side may match a position of the other end of the second fixed electrode on the third direction side, and a position of the other end of the first fixed electrode on the fourth direction side may match a position of the one end of the second movable electrode on the fourth direction side.

Thus, the number of manufacturing steps can be reduced, and the physical quantity sensor can be manufactured with high accuracy at low cost.

In the present embodiment, in the side view in the stationary state, a position of the other end of the first movable electrode on the fourth direction side may match a position of the one end of the second fixed electrode on the fourth direction side, and a position of the one end of the first fixed electrode on the third direction side may match a position of the other end of the second movable electrode on the third direction side.

Thus, the number of manufacturing steps can be further reduced, and the physical quantity sensor can be manufactured with high accuracy at low cost.

In the present embodiment, the physical quantity sensor may further include a first fixing portion; a first support beam whose one end is coupled to the first fixing portion; a first coupling portion coupling the other end of the first support beam and the first movable electrode portion; a second fixing portion; a second support beam whose one end is coupled to the second fixing portion; and a second coupling portion coupling the other end of the second support beam and the second movable electrode portion.

Thus, the acceleration can be detected by the two elements, so that it is possible to implement high sensitivity of acceleration detection. Since the mass imbalance in the second direction can be eliminated, the acceleration can be detected with high accuracy.

In the present embodiment, in the plan view in the third direction, the first movable electrode portion, the second fixing portion, the first fixing portion, and the second movable electrode portion may be arranged adjacently along the first direction in an order of the first movable electrode portion, the second fixing portion, the first fixing portion, and the second movable electrode portion.

Thus, it is possible to implement the small size of the physical quantity sensor. Since the first fixing portion and the second fixing portion can be disposed close to each other, deterioration of accuracy of the physical quantity detection due to the influence of the warpage of the substrate or the like can be minimized. Therefore, it is possible to implement both small size and high accuracy of the physical quantity sensor.

The present embodiment relates to an inertial measurement unit including a control unit configured to perform control based on a detection signal output from the physical quantity sensor.

The manufacturing method according to the present embodiment is a method of manufacturing a physical quantity sensor configured to, when three directions orthogonal to one another are defined as a first direction, a second direction, and a third direction, detect a physical quantity in the third direction, and the manufacturing method includes: a fixed electrode forming step of forming a first fixed electrode portion at a substrate; and a movable electrode forming step of forming a first movable electrode portion. The first fixed electrode portion includes a first fixed electrode, and the first movable electrode portion includes a first movable electrode facing the first fixed electrode of the first fixed electrode portion in the second direction. When a smaller thickness of a thickness of the first fixed electrode in the third direction and a thickness of the first movable electrode in the third direction is defined as TCA, in the movable electrode forming step, the first movable electrode portion is formed such that, in a side view in the second direction, one end of the first movable electrode on a third direction side is positioned on the third direction side by 4 μm or more and TCA/2 or less relative to one end of the first fixed electrode on the third direction side, and when an opposite direction of the third direction is defined as a fourth direction, the other end of the first movable electrode on a fourth direction side is positioned on the third direction side relative to the other end of the first fixed electrode on the fourth direction side.

According to the present embodiment, a sacrificial layer is formed in advance on the fourth direction side of a structure body layer, and after the process of portions corresponding to the fixed electrode and the movable electrode is ended, the sacrificial layer can be isotropically peeled off by wet etching. Therefore, the shapes of the fixed electrode and the movable electrode can be set to the shapes of the two-side offset while reducing the number of manufacturing steps and process difficulty.

Although the present embodiment is described in detail above, it can be easily understood by those skilled in the art that many modifications can be made without substantially departing from the new matters and effects of the present disclosure. Therefore, all such modifications are intended to be included within the scope of the present disclosure. For example, a term cited with a different term having a broader meaning or the same meaning at least once in the specification or in the drawings can be replaced with a different term at any place in the specification or in the drawings. All combinations of the present embodiment and the modifications are also included in the scope of the present disclosure. Configurations, operations, and the like of the physical quantity sensor, the inertial measurement unit, and the manufacturing method are not limited to those described in the present embodiment, and various modifications can be made.

What is claimed is:

1. A physical quantity sensor configured to, when three directions orthogonal to one another are defined as a first direction, a second direction, and a third direction, detect a physical quantity in the third direction, the physical quantity sensor comprising:
a first fixed electrode portion provided at a substrate; and
a movable electrode portion, wherein
the first fixed electrode portion includes a first fixed electrode,
the first movable electrode portion includes a first movable electrode facing the first fixed electrode of the first fixed electrode portion in the second direction, and
when a smaller thickness of a thickness of the first fixed electrode in the third direction and a thickness of the first movable electrode in the third direction is defined as TCA,
in a side view in the second direction in a stationary state, one end of the first movable electrode on a third direction side is positioned on the third direction side by 4 μm or more and TCA/2 or less relative to one end of the first fixed electrode on the third direction side, and when an opposite direction of the third direction is defined as a fourth direction, other end of the first movable electrode on a fourth direction side is positioned on the third direction side relative to other end of the first fixed electrode on the fourth direction side.

2. The physical quantity sensor according to claim 1, wherein
the other end of the first movable electrode on the fourth direction side is positioned on the third direction side by 4 μm or more and TCA/2 or less relative to the other end of the first fixed electrode on the fourth direction side.

3. The physical quantity sensor according to claim 1, further comprising:
a second fixed electrode portion provided at the substrate; and
a second movable electrode portion, wherein
the second fixed electrode portion includes a second fixed electrode,
the second movable electrode portion includes a second movable electrode facing the second fixed electrode of the second fixed electrode portion in the second direction, and
when a smaller thickness of a thickness of the second fixed electrode in the third direction and a thickness of the second movable electrode in the third direction is defined as TCB,
in the side view in the stationary state, one end of the second movable electrode on the fourth direction side is positioned on the fourth direction side by 4 μm or more and TCB/2 or less relative to one end of the second fixed electrode on the fourth direction side, and other end of the second movable electrode on the third direction side is positioned on the fourth direction side relative to other end of the second fixed electrode on the third direction side.

4. The physical quantity sensor according to claim 3, wherein
the other end of the second movable electrode on the third direction side is positioned on the fourth direction side by 4 μm or more and TCB/2 or less relative to the other end of the second fixed electrode on the third direction side.

5. The physical quantity sensor according to claim 3, wherein
in the side view in the stationary state, a position of the one end of the first movable electrode on the third direction side matches a position of the other end of the second fixed electrode on the third direction side, and a position of the other end of the first fixed electrode on the fourth direction side matches a position of the one end of the second movable electrode on the fourth direction side.

6. The physical quantity sensor according to claim 5, wherein
in the side view in the stationary state, a position of the other end of the first movable electrode on the fourth direction side matches a position of the one end of the second fixed electrode on the fourth direction side, and a position of the one end of the first fixed electrode on the third direction side matches a position of the other end of the second movable electrode on the third direction side.

7. The physical quantity sensor according to claim 1, further comprising:
a first fixing portion;
a first support beam whose one end is coupled to the first fixing portion;
a first coupling portion coupling other end of the first support beam and the first movable electrode portion;
a second fixing portion;
a second support beam whose one end is coupled to the second fixing portion; and
a second coupling portion coupling other end of the second support beam and the second movable electrode portion.

8. The physical quantity sensor according to claim 7, wherein
in a plan view in the third direction, the first movable electrode portion, the second fixing portion, the first fixing portion, and the second movable electrode portion are arranged adjacently along the first direction in an order of the first movable electrode portion, the second fixing portion, the first fixing portion, and the second movable electrode portion.

9. An inertial measurement unit comprising:
the physical quantity sensor according to claim 1; and
a control unit configured to perform control based on a detection signal output from the physical quantity sensor.

10. A method of manufacturing a physical quantity sensor configured to, when three directions orthogonal to one another are defined as a first direction, a second direction, and a third direction, detect a physical quantity in the third direction, the method comprising:
a fixed electrode forming step of forming a first fixed electrode portion at a substrate; and
a movable electrode forming step of forming a first movable electrode portion, wherein
the first fixed electrode portion includes a first fixed electrode,
the first movable electrode portion includes a first movable electrode facing the first fixed electrode of the first fixed electrode portion in the second direction, and
when a smaller thickness of a thickness of the first fixed electrode in the third direction and a thickness of the first movable electrode in the third direction is defined as TCA,
in the movable electrode forming step,
the first movable electrode portion is formed such that in a side view in the second direction, one end of the first movable electrode on a third direction side is positioned on the third direction side by 4 μm or more and TCA/2 or less relative to one end of the first fixed electrode on the third direction side, and when an opposite direction of the third direction is defined as a fourth direction, other end of the first movable electrode on a fourth direction side is positioned on the third direction side relative to other end of the first fixed electrode on the fourth direction side.
